(19) United States
(12) Patent Application Publication
(10) Pub. No.: US 2025/0247913 A1
(43) Pub. Date: Jul. 31, 2025

(54) ADJUSTING NON-CELL-DEFINING SSB TO CELL DTX

(71) Applicant: QUALCOMM Incorporated, San Diego, CA (US)

(72) Inventors: Mohammed JABI, San Diego, CA (US); Ahmed Attia Abotabl, San Diego, CA (US)

(21) Appl. No.: 18/428,081

(22) Filed: Jan. 31, 2024

(51) Int. Cl. H04W 76/28; H04W 48/08

(52) U.S. Cl. CPC H04W 76/28; H04W 48/08

(57) ABSTRACT

Systems, methods and apparatuses, including computer programs encoded on computer storage media for a network node and a user equipment (UE) transmit and receive a non-cell defining (NCD) synchronization signal block (SSB) when cell discontinuous transmission (DTX) applies to the NCD-SSB. The network node transmits a configuration of a NCD-SSB having a periodicity and a time offset. The network node determines a configuration of an active period and a non-active period for the cell DTX configuration. The network node drops at least one transmission of the NCD-SSB when the periodicity and the time offset indicate that the transmission is within the non-active period for the cell DTX configuration. The network node may transmit an indication of a muting pattern that indicates which transmissions of the NCD-SSB are dropped. The UE may receive the indication and receive at least one transmission of the NCD-SSB based on the muting pattern.

### TECHNICAL FIELD

The present disclosure relates to wireless communications including transmission and reception of non-cell defining synchronization signal blocks (SSBs) during cell discontinuous transmission.

### DESCRIPTION OF THE RELATED TECHNOLOGY

Wireless communication systems are widely deployed to provide various telecommunication services such as telephony, video, data, messaging, and broadcasts. Typical wireless communication systems may employ multiple-access technologies capable of supporting communication with multiple users by sharing available system resources. Examples of such multiple-access technologies include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, and time division synchronous code division multiple access (TD-SCDMA) systems.

These multiple access technologies have been adopted in various telecommunication standards to provide a common protocol that enables different wireless devices to communicate on a municipal, national, regional, and even global level. An example telecommunication standard is 5G New Radio (NR). 5G NR is part of a continuous mobile broadband evolution promulgated by Third Generation Partnership Project (3GPP) to meet new requirements associated with latency, reliability, security, scalability (such as with Internet of Things (IoT)), and other requirements. 5G NR includes services associated with enhanced mobile broadband (eMBB), massive machine type communications (mMTC), and ultra-reliable low latency communications (URLLC). Some aspects of 5G NR may be based on the 4G Long Term Evolution (LTE) standard.

### SUMMARY

The systems, methods and devices of this disclosure each have several innovative aspects, no single one of which is solely responsible for the desirable attributes disclosed herein.

In some aspects, the techniques described herein relate to a method of wireless communications for a UE, including: receiving a configuration of a non-cell defining (NCD) synchronization signal block (SSB) having a periodicity and a time offset; receiving an indication of a muting pattern that indicates which transmissions of the NCD-SSB are dropped; receiving at least one transmission of the NCD-SSB based at least in part on the muting pattern.

In some aspects, the techniques described herein relate to an apparatus for a UE, including: one or more memories, individually or in combination, storing computer-executable instructions; and one or more processors, individually or in combination, configured to execute the instructions to: receive a configuration of a non-cell defining (NCD) synchronization signal block (SSB) having a periodicity and a time offset; receive an indication of a muting pattern that indicates which transmissions of the NCD-SSB are dropped; receive at least one transmission of the NCD-SSB based at least in part on the muting pattern.

The present disclosure also provides an apparatus (e.g., a UE) including means for performing at least one of the above methods, and a non-transitory computer-readable medium storing computer-executable instructions for performing at least one of the above methods.

In some aspects, the techniques described herein relate to a method of wireless communications at a network node, including: transmitting a configuration of a non-cell defining (NCD) synchronization signal block (SSB) having a periodicity and a time offset; determining a configuration of an active period and a non-active period for a cell discontinuous transmission (DTX) configuration; and dropping at least one transmission of the NCD-SSB when the periodicity and the time offset indicate that the transmission is within the non-active period for the cell DTX configuration.

In some aspects, the techniques described herein relate to an apparatus for wireless communications at network node, including: one or more memories, individually or in combination, storing computer-executable instructions; and one or more processors, individually or in combination, configured to execute the instructions to: transmit a configuration of a non-cell defining (NCD) synchronization signal block (SSB) having a periodicity and a time offset; determine a configuration of an active period and a non-active period for a cell discontinuous transmission (DTX) configuration; and drop at least one transmission of the NCD-SSB when the periodicity and the time offset indicate that the transmission is within the non-active period for the cell DTX configuration.

The present disclosure also provides an apparatus (e.g., a network node) including means for performing at least one of the above methods, and a non-transitory computer-readable medium storing computer-executable instructions for performing at least one of the above methods.

Details of one or more implementations of the subject matter described in this disclosure are set forth in the accompanying drawings and the description below. Other features, aspects, and advantages will become apparent from the description, the drawings and the claims. Note that the relative dimensions of the following figures may not be drawn to scale.

### BRIEF DESCRIPTION OF THE DRAWINGS

FIG. 1 is a diagram illustrating an example of a wireless communications system including an access network.

FIG. 2A is a diagram illustrating an example of a first frame.

FIG. 2B is a diagram illustrating an example of DL channels within a subframe.

FIG. 2C is a diagram illustrating an example of a second frame.

FIG. 2D is a diagram illustrating an example of a subframe.

FIG. 3 is a diagram illustrating an example of a base station (BS) and user equipment (UE) in an access network.

FIG. 4 is a diagram illustrating an example disaggregated base station architecture.

FIG. 5 is a timing diagram illustrating an example relationship between a non-cell defining synchronization signal block (NCD-SSB) configuration and a cell discontinuous transmission (DTX) configuration.

FIG. 6 is a timing diagram illustrating another example relationship between an NCD-SSB configuration and a DTX configuration.

FIG. 7 is a timing diagram illustrating an example of dropping transmissions of NCD-SSB during a non-active period.

FIG. 8 is a timing diagram illustrating an example of dropping transmissions according to a muting pattern.

FIG. 9 is a message diagram illustrating various messages for applying a DTX configuration to NDC-SSB transmissions.

FIG. 10 is a conceptual data flow diagram illustrating the data flow between different means/components in an example network node.

FIG. 11 is a conceptual data flow diagram illustrating the data flow between different means/components in an example UE.

FIG. 12 is a flowchart of an example method for a UE 104 to receive a NCD-SSB when a cell DTX configuration is applicable to NCD-SSB transmission.

FIG. 13 is a flowchart of an example method for a network node (e.g., a base station, gNB, or TRP) to transmit a NCD-SSB based on a NCD-SSB configuration and a cell DTX configuration.

Like reference numbers and designations in the various drawings indicate like elements.

### DETAILED DESCRIPTION

The following description is directed to certain implementations for the purposes of describing the innovative aspects of this disclosure. However, a person having ordinary skill in the art will readily recognize that the teachings herein can be applied in a multitude of different ways. Some of the examples in this disclosure are based on wireless and wired local area network (LAN) communication according to the Institute of Electrical and Electronics Engineers (IEEE) 802.11 wireless standards, the IEEE 802.3 Ethernet standards, and the IEEE 1901 Powerline communication (PLC) standards. However, the described implementations may be implemented in any device, system or network that is capable of transmitting and receiving RF signals according to any of the wireless communication standards, including any of the IEEE 802.11 standards, the Bluetooth® standard, code division multiple access (CDMA), frequency division multiple access (FDMA), time division multiple access (TDMA), Global System for Mobile communications (GSM), GSM/General Packet Radio Service (GPRS), Enhanced Data GSM Environment (EDGE), Terrestrial Trunked Radio (TETRA), Wideband-CDMA (W-CDMA), Evolution Data Optimized (EV-DO), 1×EV-DO, EV-DO Rev A, EV-DO Rev B, High Speed Packet Access (HSPA), High Speed Downlink Packet Access (HSDPA), High Speed Uplink Packet Access (HSUPA), Evolved High Speed Packet Access (HSPA+), Long Term Evolution (LTE), AMPS, or other known signals that are used to communicate within a wireless, cellular or internet of things (IoT) network, such as a system utilizing 3G, 4G or 5G, or further implementations thereof, technology.

Wireless networks are known to consume significant amounts of power. Conventionally, efforts to reduce power consumption have focused on the user equipment (UE), which is typically battery powered and has a limited supply of energy. Power saving, however, may also be applicable to network nodes. Conventionally, such network nodes are continuously powered and consume energy. Although the energy may be continuously supplied by an electric grid, the energy consumption still has monetary and environmental costs. Accordingly, power saving for the network in addition to the UE may be beneficial.

Network energy saving may adapt techniques that are similar to power saving techniques used at the user equipment. For example, two proposed techniques are dynamic adaptation of the spatial and power domains and discontinuous transmission (DTX) and discontinuous reception (DRX) at the cell. In general, cell DTX/DRX may provide active periods in which the cell behaves normally and non-active periods in which some communications are limited. The goal of cell DTX/DRX mechanism is alignment of cell DTX/DRX and UE DRX in RRC_CONNECTED mode, and inter-node information exchange on cell DTX/DRX. Generally, cell DTX/DRX is not intended to change transmission of synchronization signal blocks (SSBs), which provide periodic reference signals and basic cell information. Accordingly, changes to SSBs may impact idle or inactive user equipment (UE).

Some networks may utilize a non-cell defining SSB (NCD-SSB). For example, a NCD-SSB may be provided for reduced capability (RedCap) UEs on a RedCap-specific initial or dedicated bandwidth part (BWP) for RedCap UEs. For instance, the NCD-SSB may allow a RedCap UE to monitor a smaller BWP, which may not include a cell-defining SSB. In some implementations, use of a NCD-SSB by a RedCap UE may be according to 3GPP TS 38.331 version 17.6.0. A RedCap UE operating in a RedCap-specific BWP uses the NCD-SSB for the purposes for which the RedCap UE would otherwise have used the cell-defining SSB of the serving cell (e.g. obtaining sync, measurements, radio link management (RLM)). Furthermore, other parts (e.g., information elements (IEs)) of the BWP configuration that refer to an SSB (e.g. the “SSB” configured in the quasi-co-location information element (QCL-Info IE); the “ssb-Index” configured in the RadioLinkMonitoringRS IE; CFRA-SSB-Resource IE; or the PRACH-ResourceDedicatedBFR IE) refer implicitly to the NCD-SSB. The NCD-SSB has the same values for the properties (e.g., ssb-PositionsInBurst, PCI, ssb-periodicity, ssb-PBCH-BlockPower) of the corresponding CD-SSB apart from the values of the properties configured in the Non-Cell Defining SSB configuration.

SSBs are primarily used during the cell search procedure. In the cell-defining SSB, the primary synchronization signal (PSS) and secondary synchronizations signal (SSS) are used for initial time and frequency synchronization, identifying the physical cell identity (PCI) and measuring reference signal received power (RSRP), reference signal received quality (RSRQ), and signal to interference plus noise ration (SINR). The SSB also includes a physical broadcast channel (PBCH) used to broadcast the master information block, which provides the UE with information regarding a control resource set (CORESET) and search space used by the PDCCH that transfers a first system information block (SIB1). SIB1 provides the UE with the scheduling for all other system information.

In a NCD-SSB, the MIB is not associated with SIB1. Accordingly, the NCD-SSB may not be used for initial cell access. Therefore, there may be benefits of applying cell DTX to NCD-SSB transmissions. However, the timing of NCD-SSB transmissions may not align with a cell DTX configuration. There is need for techniques for determining whether a NCD-SSB transmission is to occur when cell DTX applies to NCD-SSB transmissions.

In an aspect, the present disclosure provides techniques for dropping at least one transmission of the NCD-SSB based on a configuration of the NCD-SSB and a cell DTX configuration. A network node (e.g., a cell) may broadcast the configuration of the NCD-SSB, for example, as one or more radio resource control (RRC) messages. The configuration of the NCD-SSB may define transmission of the NCD-SSB based on a periodicity and a time offset. The network node determines a configuration of an active period and a non-active period for the cell DTX configuration. The network node does not necessarily transmit the cell DTX configuration to a UE. The network node may drop the at least one transmission of the NCD-SSB when the periodicity and the time offset indicate that the transmission is within the non-active period for the cell DTX configuration. In some implementations, the network node does not drop all NCD-SSB within the non-active period. In some implementations, the network node transmits an indication of a muting pattern that indicates which transmissions of the NCD-SSB are dropped. The UE may receive the configuration of the NCD-SSB from the network node. The UE may receive the indication of the muting pattern. Accordingly, the UE may receive at least one transmission of the NCD-SSB based at least in part on the muting pattern. For instance, the UE may receive at least one transmission of the NCD-SSB that is not dropped. In some implementations, the UE may refrain from receiving a transmission of the NCD-SSB that is dropped, for example, to save power at the UE.

The techniques disclosed herein may be implemented to realize one or more of the following technical effects. Application of a cell DTX configuration to a NCD-SSB may provide power savings at a network node. In some implementations, a UE may also save power by refraining from receiving NCD-SSB transmissions that have been dropped. In some implementations, where the muting pattern indicates that a NCD-SSB prior to an active period is not dropped, the UE may still perform relevant measurements while realizing power savings.

Several aspects of telecommunication systems will now be presented with reference to various apparatus and methods. These apparatus and methods will be described in the following detailed description and illustrated in the accompanying drawings by various blocks, components, circuits, processes, algorithms, etc. (collectively referred to as “elements”). These elements may be implemented using electronic hardware, computer software, or any combination thereof. Whether such elements are implemented as hardware or software depends upon the particular application and design constraints imposed on the overall system.

By way of example, an element, or any portion of an element, or any combination of elements may be implemented as a “processing system” that includes one or more processors. Examples of processors include microprocessors, microcontrollers, graphics processing units (GPUs), central processing units (CPUs), application processors, digital signal processors (DSPs), reduced instruction set computing (RISC) processors, systems on a chip (SoC), baseband processors, field programmable gate arrays (FPGAs), programmable logic devices (PLDs), state machines, gated logic, discrete hardware circuits, and other suitable hardware configured to perform the various functionality described throughout this disclosure. The processor may include an interface or be coupled to an interface that can obtain or output signals. The processor may obtain signals via the interface and output signals via the interface. In some implementations, the interface may be a printed circuit board (PCB) transmission line. In some other implementations, the interface may include a wireless transmitter, a wireless transceiver, or a combination thereof. For example, the interface may include a radio frequency (RF) transceiver which can be implemented to receive or transmit signals, or both. One or more processors in the processing system may execute software. Software shall be construed broadly to mean instructions, instruction sets, code, code segments, program code, programs, subprograms, software components, applications, software applications, software packages, routines, subroutines, objects, executables, threads of execution, procedures, functions, etc., whether referred to as software, firmware, middleware, microcode, hardware description language, or otherwise.

Accordingly, in one or more example implementations, the functions described may be implemented in hardware, software, or any combination thereof. If implemented in software, the functions may be stored on or encoded as one or more instructions or code on a computer-readable medium. Computer-readable media includes computer storage media, which may be referred to as non-transitory computer-readable media. Non-transitory computer-readable media may exclude transitory signals. Storage media may be any available media that can be accessed by a computer. By way of example, and not limitation, such computer-readable media can include a random-access memory (RAM), a read-only memory (ROM), an electrically erasable programmable ROM (EEPROM), optical disk storage, magnetic disk storage, other magnetic storage devices, combinations of the aforementioned types of computer-readable media, or any other medium that can be used to store computer executable code in the form of instructions or data structures that can be accessed by a computer.

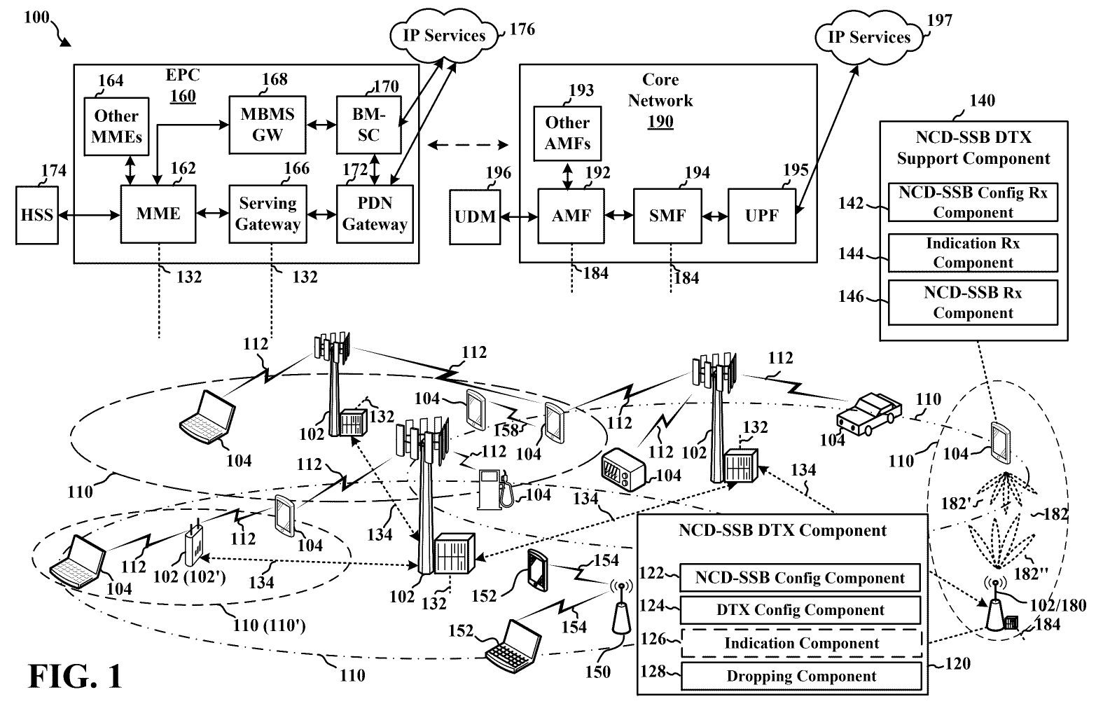

FIG. 1 is a diagram illustrating an example of a wireless communications system and an access network 100. The wireless communications system (also referred to as a wireless wide area network (WWAN)) includes base stations 102, UEs 104, an Evolved Packet Core (EPC) 160, and another core network 190 (such as a 5G Core (5GC)). The base stations 102 may include macrocells (high power cellular base station) or small cells (low power cellular base station). The macrocells include base stations. The small cells include femtocells, picocells, and microcells. The small cells include femtocells, picocells, and microcells. The base stations 102 can be configured in a Disaggregated RAN (D-RAN) or Open RAN (O-RAN) architecture, where functionality is split between multiple units such as a central unit (CU), one or more distributed units (DUs), or a radio unit (RU). Such architectures may be configured to utilize a protocol stack that is logically split between one or more units (such as one or more CUs and one or more DUs). In some aspects, the CUs may be implemented within an edge RAN node, and in some aspects, one or more DUs may be co-located with a CU, or may be geographically distributed throughout one or multiple RAN nodes. The DUs may be implemented to communicate with one or more RUs.

In some implementations, one or more of the UEs 104 include a NCD-SSB DTX support component 140 configured receive a NCD-SSB when cell DTX is configured. The NCD-SSB DTX support component 140 includes a NCD-SSB Config receiving (Rx) component 142, an indication Rx component 144, and an NCD-SSB Rx component 146. The NCD-SSB Config Rx component 142 is configured to receive a configuration of a non-cell defining (NCD) synchronization signal block (SSB) having a periodicity and a time offset. The indication Rx component 144 is configured to receive an indication of a muting pattern that indicates which transmissions of the NCD-SSB are dropped. The NCD-SSB Rx component 146 is configured to receive at least one transmission of the NCD-SSB based at least in part on the muting pattern.

In some implementations, one or more of the base stations 102 include a NCD-SSB DTX component 120 configured to transmit NCD-SSB according to both a NCD-SSB configuration and a cell DTX configuration. The NCD-SSB DTX component 120 includes a NCD-SSB configuration (config) component 122, a DTX config component 124, and a dropping component 128. The NCD-SSB DTX component 120 may optionally include an indication component 126. The NCD-SSB config component 122 is configured to transmit a configuration of a non-cell defining (NCD) synchronization signal block (SSB) having a periodicity and a time offset. The dropping component 128 is configured to drop at least one transmission of the NCD-SSB when the periodicity and the time offset indicate that the transmission is within the non-active period for the cell DTX configuration. The optional indication component 126 is configured to transmit an indication of a muting pattern that indicates which transmissions of the NCD-SSB are dropped.

The base stations 102 configured for 4G LTE (collectively referred to as Evolved Universal Mobile Telecommunications System (UMTS) Terrestrial Radio Access Network (E-UTRAN)) may interface with the EPC 160 through first backhaul links 132 (such as S1 interface), which may be wired or wireless. The base stations 102 configured for 5G NR (collectively referred to as Next Generation RAN (NG-RAN)) may interface with core network 190 through second backhaul links 184, which may be wired or wireless. In addition to other functions, the base stations 102 may perform one or more of the following functions: transfer of user data, radio channel ciphering and deciphering, integrity protection, header compression, mobility control functions (such as handover, dual connectivity), inter-cell interference coordination, connection setup and release, load balancing, distribution for non-access stratum (NAS) messages, NAS node selection, synchronization, radio access network (RAN) sharing, multimedia broadcast multicast service (MBMS), subscriber and equipment trace, RAN information management (RIM), paging, positioning, and delivery of warning messages. The base stations 102 may communicate directly or indirectly (such as through the EPC 160 or core network 190) with each other over third backhaul links 134 (such as X2 interface). The third backhaul links 134 may be wired or wireless.

The base stations 102 may wirelessly communicate with the UEs 104. Each of the base stations 102 may provide communication coverage for a respective geographic coverage area 110. There may be overlapping geographic coverage areas 110. For example, the small cell 102′ may have a coverage area 110′ that overlaps the coverage area 110 of one or more macro base stations 102. A network that includes both small cell and macrocells may be known as a heterogeneous network. A heterogeneous network also may include Home Evolved Node Bs (eNBs) (HeNBs), which may provide service to a restricted group known as a closed subscriber group (CSG). The communication links 112 between the base stations 102 and the UEs 104 may include UL (also referred to as reverse link) transmissions from a UE 104 to a base station 102 or DL (also referred to as forward link) transmissions from a base station 102 to a UE 104. The communication links 112 may use multiple-input and multiple-output (MIMO) antenna technology, including spatial multiplexing, beamforming, or transmit diversity. The communication links may be through one or more carriers. The base stations 102/UEs 104 may use spectrum up to Y MHz (such as 5, 10, 15, 20, 100, 400, etc. MHz) bandwidth per carrier allocated in a carrier aggregation of up to a total of Yx MHz (x component carriers) used for transmission in each direction. The carriers may or may not be adjacent to each other.

Allocation of carriers may be asymmetric with respect to DL and UL (such as more or fewer carriers may be allocated for DL than for UL). The component carriers may include a primary component carrier and one or more secondary component carriers. A primary component carrier may be referred to as a primary cell (PCell) and a secondary component carrier may be referred to as a secondary cell (SCell).

Certain UEs 104 may communicate with each other using device-to-device (D2D) communication link 158. The D2D communication link 158 may use the DL/UL WWAN spectrum. The D2D communication link 158 may use one or more sidelink channels, such as a physical sidelink broadcast channel (PSBCH), a physical sidelink discovery channel (PSDCH), a physical sidelink shared channel (PSSCH), and a physical sidelink control channel (PSCCH). D2D communication may be through a variety of wireless D2D communications systems, such as for example, FlashLinQ, WiMedia, Bluetooth, ZigBee, Wi-Fi based on the IEEE 802.11 standard, LTE, or NR.

The wireless communications system may further include a Wi-Fi access point (AP) 150 in communication with Wi-Fi stations (STAs) 152 via communication links 154 in a 5 GHz unlicensed frequency spectrum. When communicating in an unlicensed frequency spectrum, the STAs 152/AP 150 may perform a clear channel assessment (CCA) prior to communicating in order to determine whether the channel is available.

The small cell 102′ may operate in a licensed or an unlicensed frequency spectrum. When operating in an unlicensed frequency spectrum, the small cell 102′ may employ NR and use the same 5 GHz unlicensed frequency spectrum as used by the Wi-Fi AP 150. The small cell 102′, employing NR in an unlicensed frequency spectrum, may boost coverage to or increase capacity of the access network.

A base station 102, whether a small cell 102′ or a large cell (such as macro base station), may include an eNB, gNodeB (gNB), or other type of base station. Some base stations, such as gNB 180 may operate in one or more frequency bands within the electromagnetic spectrum.

The electromagnetic spectrum is often subdivided, based on frequency/wavelength, into various classes, bands, channels, etc. In 5G NR two initial operating bands have been identified as frequency range designations FR1 (410 MHz-7.125 GHz) and FR2 (24.25 GHz-52.6 GHz). The frequencies between FR1 and FR2 are often referred to as mid-band frequencies. Although a portion of FR1 is greater than 6 GHz, FR1 is often referred to (interchangeably) as a “Sub-6 GHz” band in various documents and articles. A similar nomenclature issue sometimes occurs with regard to FR2, which is often referred to (interchangeably) as a “millimeter wave” (mmW) band in documents and articles, despite being different from the extremely high frequency (EHF) band (30 GHz-300 GHz) which is identified by the International Telecommunications Union (ITU) as a “millimeter wave” band.

With the above aspects in mind, unless specifically stated otherwise, it should be understood that the term “sub-6 GHz” or the like if used herein may broadly represent frequencies that may be less than 6 GHz, may be within FR1, or may include mid-band frequencies. Further, unless specifically stated otherwise, it should be understood that the term “millimeter wave” or the like if used herein may broadly represent frequencies that may include mid-band frequencies, may be within FR2, or may be within the EHF band. Communications using the mmW radio frequency band have extremely high path loss and a short range. The mmW base station 180 may utilize beamforming 182 with the UE 104 to compensate for the path loss and short range.

The EPC 160 may include a Mobility Management Entity (MME) 162, other MMEs 164, a Serving Gateway 166, a Multimedia Broadcast Multicast Service (MBMS) Gateway 168, a Broadcast Multicast Service Center (BM-SC) 170, and a Packet Data Network (PDN) Gateway 172. The MME 162 may be in communication with a Home Subscriber Server (HSS) 174. The MME 162 is the control node that processes the signaling between the UEs 104 and the EPC 160. Generally, the MME 162 provides bearer and connection management. All user Internet protocol (IP) packets are transferred through the Serving Gateway 166, which itself is connected to the PDN Gateway 172. The PDN Gateway 172 provides UE IP address allocation as well as other functions. The PDN Gateway 172 and the BM-SC 170 are connected to the IP Services 176. The IP Services 176 may include the Internet, an intranet, an IP Multimedia Subsystem (IMS), a PS Streaming Service, or other IP services. The BM-SC 170 may provide functions for MBMS user service provisioning and delivery. The BM-SC 170 may serve as an entry point for content provider MBMS transmission, may be used to authorize and initiate MBMS Bearer Services within a public land mobile network (PLMN), and may be used to schedule MBMS transmissions. The MBMS Gateway 168 may be used to distribute MBMS traffic to the base stations 102 belonging to a Multicast Broadcast Single Frequency Network (MBSFN) area broadcasting a particular service, and may be responsible for session management (start/stop) and for collecting eMBMS related charging information.

The core network 190 may include an Access and Mobility Management Function (AMF) 192, other AMFs 193, a Session Management Function (SMF) 194, and a User Plane Function (UPF) 195. The AMF 192 may be in communication with a Unified Data Management (UDM) 196. The AMF 192 is the control node that processes the signaling between the UEs 104 and the core network 190. Generally, the AMF 192 provides QoS flow and session management. All user Internet protocol (IP) packets are transferred through the UPF 195. The UPF 195 provides UE IP address allocation as well as other functions. The UPF 195 is connected to the IP Services 197. The IP Services 197 may include the Internet, an intranet, an IP Multimedia Subsystem (IMS), a PS Streaming Service, or other IP services.

The base station may include or be referred to as a gNB, Node B, eNB, an access point, a base transceiver station, a radio base station, a radio transceiver, a transceiver function, a basic service set (BSS), an extended service set (ESS), a transmit reception point (TRP), or some other suitable terminology. The base station 102 provides an access point to the EPC 160 or core network 190 for a UE 104. Examples of UEs 104 include a cellular phone, a smart phone, a session initiation protocol (SIP) phone, a laptop, a personal digital assistant (PDA), a satellite radio, a global positioning system, a multimedia device, a video device, a digital audio player (such as a MP3 player), a camera, a game console, a tablet, a smart device, a wearable device, a vehicle, an electric meter, a gas pump, a large or small kitchen appliance, a healthcare device, an implant, a sensor/actuator, a display, or any other similar functioning device. Some of the UEs 104 may be referred to as IoT devices (such as a parking meter, gas pump, toaster, vehicles, heart monitor, etc.). The UE 104 also may be referred to as a station, a mobile station, a subscriber station, a mobile unit, a subscriber unit, a wireless unit, a remote unit, a mobile device, a wireless device, a wireless communications device, a remote device, a mobile subscriber station, an access terminal, a mobile terminal, a wireless terminal, a remote terminal, a handset, a user agent, a mobile client, a client, or some other suitable terminology.

Although the following description may be focused on 5G NR, the concepts described herein may be applicable to other similar areas, such as LTE, LTE-A, CDMA, GSM, and other wireless technologies including future 6G technologies.

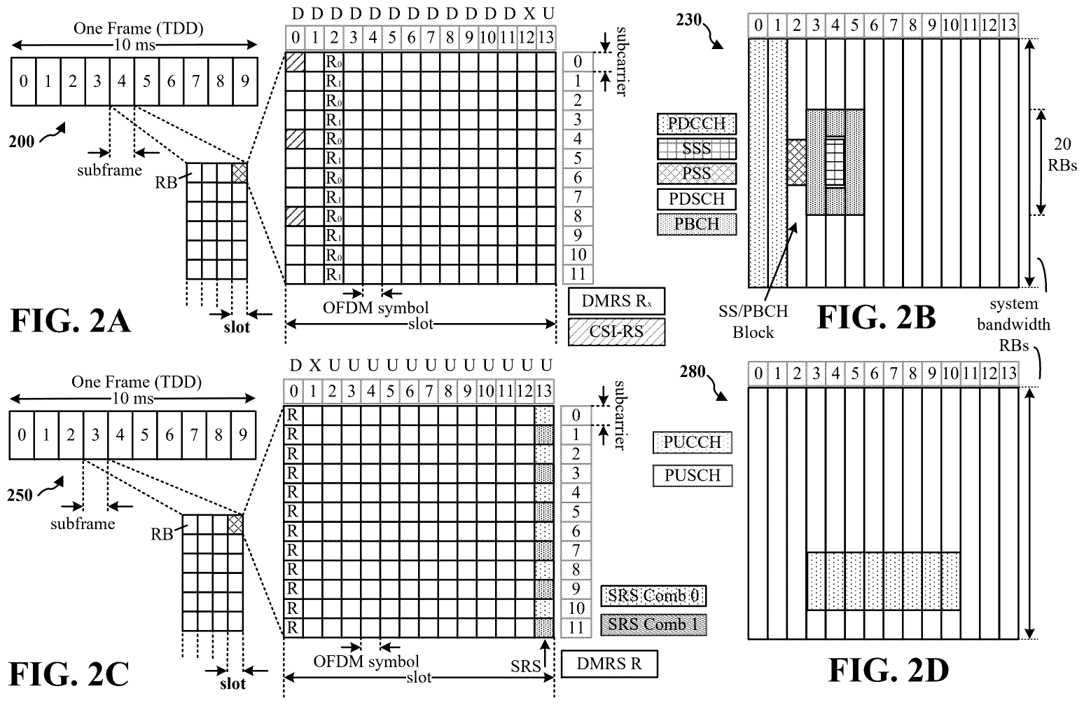

FIG. 2A is a diagram 200 illustrating an example of a first frame. FIG. 2B is a diagram 230 illustrating an example of DL channels within a subframe. FIG. 2C is a diagram 250 illustrating an example of a second frame. FIG. 2D is a diagram 280 illustrating an example of a subframe. The 5G NR frame structure may be FDD in which for a particular set of subcarriers (carrier system bandwidth), subframes within the set of subcarriers are dedicated for either DL or UL, or may be TDD in which for a particular set of subcarriers (carrier system bandwidth), subframes within the set of subcarriers are dedicated for both DL and UL. A subset of the total cell bandwidth of a cell is referred to as a Bandwidth Part (BWP) and bandwidth adaptation is achieved by configuring the UE with BWP(s) and telling the UE which of the configured BWPs is currently the active one. In an aspect, a narrow bandwidth part (NBWP) refers to a BWP having a bandwidth less than or equal to a maximum configurable bandwidth of a BWP. The bandwidth of the NBWP is less than the carrier system bandwidth.

In the examples provided by FIGS. 2A, 2C, the 5G NR frame structure is assumed to be TDD, with subframe 4 being configured with slot format 28 (with mostly DL), where D is DL, U is UL, and X is flexible for use between DL/UL, and subframe 3 being configured with slot format 34 (with mostly UL). While subframes 3, 4 are shown with slot formats 34, 28, respectively, any particular subframe may be configured with any of the various available slot formats 0-61. Slot formats 0, 1 are all DL, UL, respectively. Other slot formats 2-61 include a mix of DL, UL, and flexible symbols. UEs are configured with the slot format (dynamically through DL control information (DCI), or semi-statically/statically through radio resource control (RRC) signaling) through a received slot format indicator (SFI). Note that the description infra applies also to a 5G NR frame structure that is TDD.

Other wireless communication technologies may have a different frame structure or different channels. A frame (10 milliseconds (ms)) may be divided into 10 equally sized subframes (1 ms). Each subframe may include one or more time slots. Subframes also may include mini-slots, which may include 7, 4, or 2 symbols. Each slot may include 7 or 14 symbols, depending on the slot configuration. For slot configuration 0, each slot may include 14 symbols, and for slot configuration 1, each slot may include 7 symbols. The symbols on DL may be cyclic prefix (CP) OFDM (CP-OFDM) symbols. The symbols on UL may be CP-OFDM symbols (for high throughput scenarios) or discrete Fourier transform (DFT) spread OFDM (DFT-s-OFDM) symbols (also referred to as single carrier frequency-division multiple access (SC-FDMA) symbols) (for power limited scenarios; limited to a single stream transmission). The number of slots within a subframe is based on the slot configuration and the numerology. For slot configuration 0, different numerologies μ 0 to 5 allow for 1, 2, 4, 8, 16, and 32 slots, respectively, per subframe. For slot configuration 1, different numerologies 0 to 2 allow for 2, 4, and 8 slots, respectively, per subframe. Accordingly, for slot configuration 0 and numerology p, there are 14 symbols/slot and 2 slots/subframe. The subcarrier spacing and symbol length/duration are a function of the numerology. The subcarrier spacing may be equal to 2^{μ}*15 kHz, where y is the numerology 0 to 5. As such, the numerology p=0 has a subcarrier spacing of 15 kHz and the numerology p=5 has a subcarrier spacing of 480 kHz. The symbol length/duration is inversely related to the subcarrier spacing. FIGS. 2A-2D provide an example of slot configuration 0 with 14 symbols per slot and numerology p=2 with 4 slots per subframe. The slot duration is 0.25 ms, the subcarrier spacing is 60 kHz, and the symbol duration is approximately 16.67 microseconds (s).

A resource grid may be used to represent the frame structure. Each time slot includes a resource block (RB) (also referred to as physical RBs (PRBs)) that extends 12 consecutive subcarriers. The resource grid is divided into multiple resource elements (REs). The number of bits carried by each RE depends on the modulation scheme.

As illustrated in FIG. 2A, some of the REs carry reference (pilot) signals (RS) for the UE. The RS may include demodulation RS (DM-RS) (indicated as Rx for one particular configuration, where 100× is the port number, but other DM-RS configurations are possible) and channel state information reference signals (CSI-RS) for channel estimation at the UE. The RS also may include beam measurement RS (BRS), beam refinement RS (BRRS), and phase tracking RS (PT-RS).

FIG. 2B illustrates an example of various DL channels within a subframe of a frame. The physical downlink control channel (PDCCH) carries DCI within one or more control channel elements (CCEs), each CCE including nine RE groups (REGs), each REG including four consecutive REs in an OFDM symbol. A primary synchronization signal (PSS) may be within symbol 2 of particular subframes of a frame. The PSS is used by a UE 104 to determine subframe/symbol timing and a L1 identity. A secondary synchronization signal (SSS) may be within symbol 4 of particular subframes of a frame. The SSS is used by a UE to determine a L1 cell identity group number and radio frame timing. Based on the L1 identity and the L1 cell identity group number, the UE can determine a physical cell identifier (PCI). Based on the PCI, the UE can determine the locations of the aforementioned DM-RS. The physical broadcast channel (PBCH), which carries a master information block (MIB), may be logically grouped with the PSS and SSS to form a synchronization signal (SS)/PBCH block (SSB). The MIB provides a number of RBs in the system bandwidth and a system frame number (SFN). The physical downlink shared channel (PDSCH) carries user data, broadcast system information not transmitted through the PBCH such as system information blocks (SIBs), and paging messages.

As illustrated in FIG. 2C, some of the REs carry DM-RS (indicated as R for one particular configuration, but other DM-RS configurations are possible) for channel estimation at the base station. The UE may transmit DM-RS for the physical uplink control channel (PUCCH) and DM-RS for the physical uplink shared channel (PUSCH). The PUSCH DM-RS may be transmitted in the first one or two symbols of the PUSCH. The PUCCH DM-RS may be transmitted in different configurations depending on whether short or long PUCCHs are transmitted and depending on the particular PUCCH format used. The UE may transmit sounding reference signals (SRS). The SRS may be transmitted in the last symbol of a subframe. The SRS may have a comb structure, and a UE may transmit SRS on one of the combs. The SRS may be used by a base station for channel quality estimation to enable frequency-dependent scheduling on the UL.

FIG. 2D illustrates an example of various UL channels within a subframe of a frame. The PUCCH may be located as indicated in one configuration. The PUCCH carries uplink control information (UCI), such as scheduling requests, a channel quality indicator (CQI), a precoding matrix indicator (PMI), a rank indicator (RI), and HARQ ACK/NACK feedback. The PUSCH carries data, and may additionally be used to carry a buffer status report (BSR), a power headroom report (PHR), or UCI.

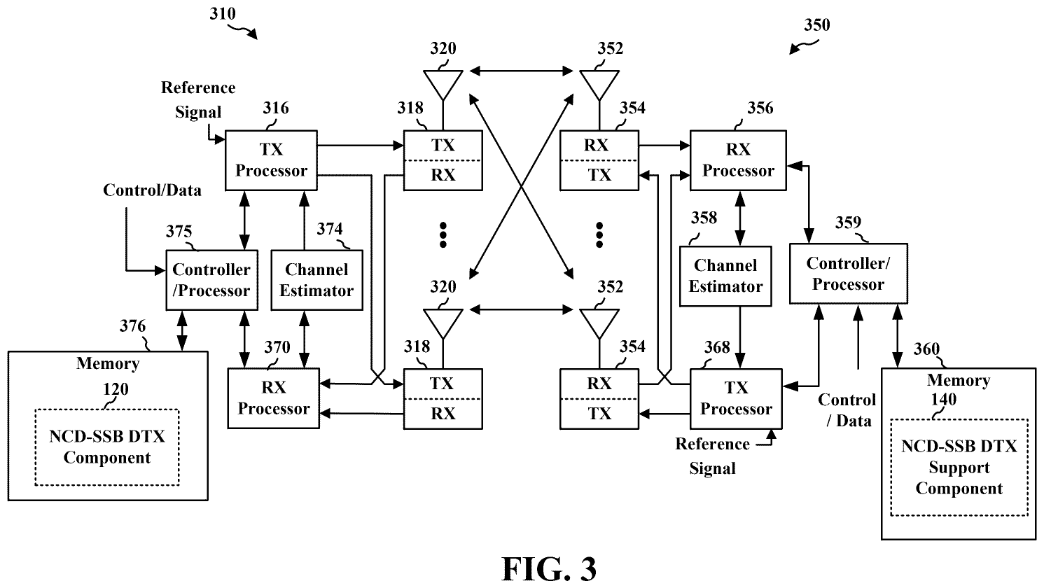

FIG. 3 is a diagram of an example of a base station 310 and a UE 350 in an access network. In the DL, IP packets from the EPC 160 may be provided to a controller/processor 375. The controller/processor 375 implements layer 3 and layer 2 functionality. Layer 3 includes a radio resource control (RRC) layer, and layer 2 includes a service data adaptation protocol (SDAP) layer, a packet data convergence protocol (PDCP) layer, a radio link control (RLC) layer, and a medium access control (MAC) layer. The controller/processor 375 provides RRC layer functionality associated with broadcasting of system information (such as MIB, SIBs), RRC connection control (such as RRC connection paging, RRC connection establishment, RRC connection modification, and RRC connection release), inter radio access technology (RAT) mobility, and measurement configuration for UE measurement reporting; PDCP layer functionality associated with header compression/decompression, security (ciphering, deciphering, integrity protection, integrity verification), and handover support functions; RLC layer functionality associated with the transfer of upper layer packet data units (PDUs), error correction through ARQ, concatenation, segmentation, and reassembly of RLC service data units (SDUs), re-segmentation of RLC data PDUs, and reordering of RLC data PDUs; and MAC layer functionality associated with mapping between logical channels and transport channels, multiplexing of MAC SDUs onto transport blocks (TBs), demultiplexing of MAC SDUs from TBs, scheduling information reporting, error correction through HARQ, priority handling, and logical channel prioritization.

The transmit (TX) processor 316 and the receive (RX) processor 370 implement layer 1 functionality associated with various signal processing functions. Layer 1, which includes a physical (PHY) layer, may include error detection on the transport channels, forward error correction (FEC) coding/decoding of the transport channels, interleaving, rate matching, mapping onto physical channels, modulation/demodulation of physical channels, and MIMO antenna processing. The TX processor 316 handles mapping to signal constellations based on various modulation schemes (such as binary phase-shift keying (BPSK), quadrature phase-shift keying (QPSK), M-phase-shift keying (M-PSK), M-quadrature amplitude modulation (M-QAM)). The coded and modulated symbols may be split into parallel streams. Each stream may be mapped to an OFDM subcarrier, multiplexed with a reference signal (such as a pilot) in the time or frequency domain, and combined together using an Inverse Fast Fourier Transform (IFFT) to produce a physical channel carrying a time domain OFDM symbol stream. The OFDM stream is spatially precoded to produce multiple spatial streams. Channel estimates from a channel estimator 374 may be used to determine the coding and modulation scheme, as well as for spatial processing. The channel estimate may be derived from a reference signal or channel condition feedback transmitted by the UE 350. Each spatial stream may be provided to a different antenna 320 via a separate transmitter 318TX. Each transmitter 318TX may modulate an RF carrier with a respective spatial stream for transmission.

At the UE 350, each receiver 354RX receives a signal through its respective antenna 352. Each receiver 354RX recovers information modulated onto an RF carrier and provides the information to the receive (RX) processor 356. The TX processor 368 and the RX processor 356 implement layer 1 functionality associated with various signal processing functions. The RX processor 356 may perform spatial processing on the information to recover any spatial streams destined for the UE 350. If multiple spatial streams are destined for the UE 350, they may be combined by the RX processor 356 into a single OFDM symbol stream. The RX processor 356 converts the OFDM symbol stream from the time-domain to the frequency domain using a Fast Fourier Transform (FFT). The frequency domain signal includes a separate OFDM symbol stream for each subcarrier of the OFDM signal. The symbols on each subcarrier, and the reference signal, are recovered and demodulated by determining the most likely signal constellation points transmitted by the base station 310. These soft decisions may be based on channel estimates computed by the channel estimator 358. The soft decisions are decoded and deinterleaved to recover the data and control signals that were originally transmitted by the base station 310 on the physical channel. The data and control signals are provided to the controller/processor 359, which implements layer 3 and layer 2 functionality.

The controller/processor 359 can be associated with a memory 360 that stores program codes and data. The memory 360 may be referred to as a computer-readable medium. In the UL, the controller/processor 359 provides demultiplexing between transport and logical channels, packet reassembly, deciphering, header decompression, and control signal processing to recover IP packets from the EPC 160. The controller/processor 359 is also responsible for error detection using an ACK or NACK protocol to support HARQ operations.

Similar to the functionality described in connection with the DL transmission by the base station 310, the controller/processor 359 provides RRC layer functionality associated with system information (such as MIB, SIBs) acquisition, RRC connections, and measurement reporting; PDCP layer functionality associated with header compression/decompression, and security (ciphering, deciphering, integrity protection, integrity verification); RLC layer functionality associated with the transfer of upper layer PDUs, error correction through ARQ, concatenation, segmentation, and reassembly of RLC SDUs, re-segmentation of RLC data PDUs, and reordering of RLC data PDUs; and MAC layer functionality associated with mapping between logical channels and transport channels, multiplexing of MAC SDUs onto TBs, demultiplexing of MAC SDUs from TBs, scheduling information reporting, error correction through HARQ, priority handling, and logical channel prioritization.

Channel estimates derived by a channel estimator 358 from a reference signal or feedback transmitted by the base station 310 may be used by the TX processor 368 to select the appropriate coding and modulation schemes, and to facilitate spatial processing. The spatial streams generated by the TX processor 368 may be provided to different antenna 352 via separate transmitters 354TX. Each transmitter 354TX may modulate an RF carrier with a respective spatial stream for transmission.

The UL transmission is processed at the base station 310 in a manner similar to that described in connection with the receiver function at the UE 350. Each receiver 318RX receives a signal through its respective antenna 320. Each receiver 318RX recovers information modulated onto an RF carrier and provides the information to a RX processor 370.

The controller/processor 375 can be associated with a memory 376 that stores program codes and data. The memory 376 may be referred to as a computer-readable medium. In the UL, the controller/processor 375 provides demultiplexing between transport and logical channels, packet reassembly, deciphering, header decompression, control signal processing to recover IP packets from the UE 350. IP packets from the controller/processor 375 may be provided to the EPC 160. The controller/processor 375 is also responsible for error detection using an ACK or NACK protocol to support HARQ operations.

At least one of the TX processor 368, the RX processor 356, and the controller/processor 359 may be configured to perform aspects in connection with the NCD-SSB DTX support component 140 of FIG. 1. For example, the memory 360 may include executable instructions defining the NCD-SSB DTX support component 140. The TX processor 368, the RX processor 356, and/or the controller/processor 359 may be configured to execute the NCD-SSB DTX support component 140.

At least one of the TX processor 316, the RX processor 370, and the controller/processor 375 may be configured to perform aspects in connection with the NCD-SSB DTX component 120 of FIG. 1. For example, the memory 376 may include executable instructions defining the NCD-SSB DTX component 120. The TX processor 316, the RX processor 370, and/or the controller/processor 375 may be configured to execute the NCD-SSB DTX component 120.

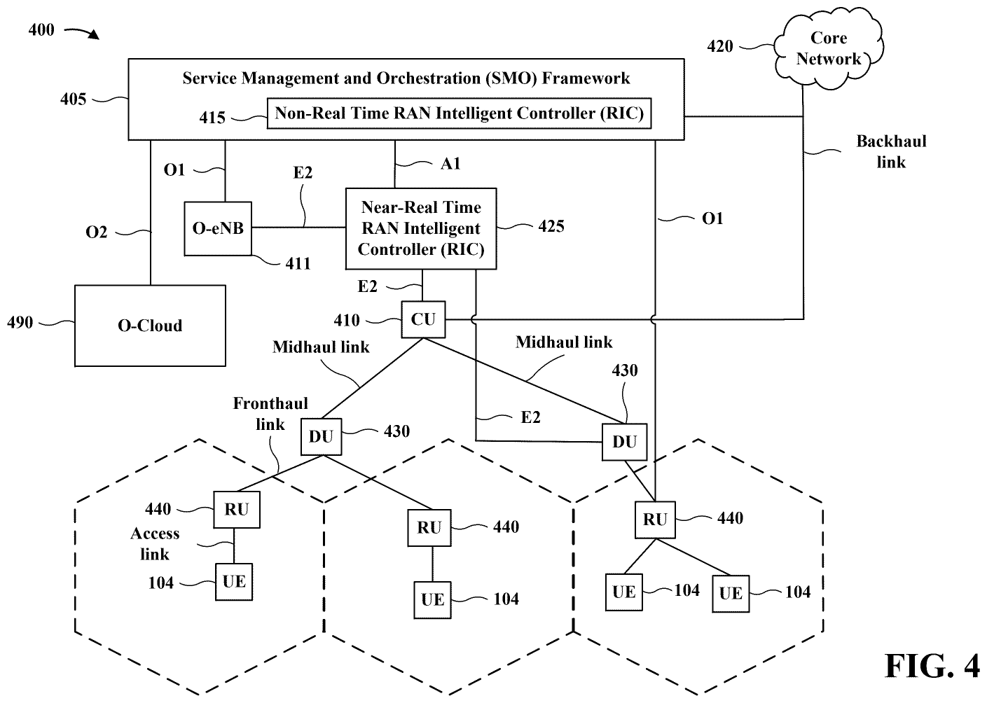

FIG. 4 is a diagram illustrating an example disaggregated base station 400 architecture. The disaggregated base station 400 architecture may include one or more central units (CUs) 410 that can communicate directly with a core network 420 via a backhaul link, or indirectly with the core network 420 through one or more disaggregated base station units (such as a Near-Real Time (Near-RT) RAN Intelligent Controller (RIC) 425 via an E2 link, or a Non-Real Time (Non-RT) RIC 415 associated with a Service Management and Orchestration (SMO) Framework 405, or both). A CU 410 may communicate with one or more distributed units (DUs) 430 via respective midhaul links, such as an F1 interface. The DUs 430 may communicate with one or more radio units (RUs) 440 via respective fronthaul links. The RUs 440 may communicate with respective UEs 104 via one or more radio frequency (RF) access links. In some implementations, the UE 104 may be simultaneously served by multiple RUs 440.

Each of the units, i.e., the CUs 410, the DUs 430, the RUs 440, as well as the Near-RT RICs 425, the Non-RT RICs 415 and the SMO Framework 405, may include one or more interfaces or be coupled to one or more interfaces configured to receive or transmit signals, data, or information (collectively, signals) via a wired or wireless transmission medium. Each of the units, or an associated processor or controller providing instructions to the communication interfaces of the units, can be configured to communicate with one or more of the other units via the transmission medium. For example, the units can include a wired interface configured to receive or transmit signals over a wired transmission medium to one or more of the other units. Additionally, the units can include a wireless interface, which may include a receiver, a transmitter or transceiver (such as a radio frequency (RF) transceiver), configured to receive or transmit signals, or both, over a wireless transmission medium to one or more of the other units.

In some aspects, the CU 410 may host one or more higher layer control functions. Such control functions can include radio resource control (RRC), packet data convergence protocol (PDCP), service data adaptation protocol (SDAP), or the like. Each control function can be implemented with an interface configured to communicate signals with other control functions hosted by the CU 410. The CU 410 may be configured to handle user plane functionality (i.e., Central Unit—User Plane (CU-UP)), control plane functionality (i.e., Central Unit—Control Plane (CU-CP)), or a combination thereof. In some implementations, the CU 410 can be logically split into one or more CU-UP units and one or more CU-CP units. The CU-UP unit can communicate bidirectionally with the CU-CP unit via an interface, such as the E1 interface when implemented in an O-RAN configuration. The CU 410 can be implemented to communicate with the DU 430, as necessary, for network control and signaling.

The DU 430 may correspond to a logical unit that includes one or more base station functions to control the operation of one or more RUs 440. In some aspects, the DU 430 may host one or more of a radio link control (RLC) layer, a medium access control (MAC) layer, and one or more high physical (PHY) layers (such as modules for forward error correction (FEC) encoding and decoding, scrambling, modulation and demodulation, or the like) depending, at least in part, on a functional split, such as those defined by the 3^{rd} Generation Partnership Project (3GPP). In some aspects, the DU 430 may further host one or more low PHY layers. Each layer (or module) can be implemented with an interface configured to communicate signals with other layers (and modules) hosted by the DU 430, or with the control functions hosted by the CU 410.

Lower-layer functionality can be implemented by one or more RUs 440. In some deployments, an RU 440, controlled by a DU 430, may correspond to a logical node that hosts RF processing functions, or low-PHY layer functions (such as performing fast Fourier transform (FFT), inverse FFT (iFFT), digital beamforming, physical random access channel (PRACH) extraction and filtering, or the like), or both, based at least in part on the functional split, such as a lower layer functional split. In such an architecture, the RU(s) 440 can be implemented to handle over the air (OTA) communication with one or more UEs 104. In some implementations, real-time and non-real-time aspects of control and user plane communication with the RU(s) 440 can be controlled by the corresponding DU 430. In some scenarios, this configuration can enable the DU(s) 430 and the CU 410 to be implemented in a cloud-based RAN architecture, such as a vRAN architecture.

The SMO Framework 405 may be configured to support RAN deployment and provisioning of non-virtualized and virtualized network elements. For non-virtualized network elements, the SMO Framework 405 may be configured to support the deployment of dedicated physical resources for RAN coverage requirements which may be managed via an operations and maintenance interface (such as an O1 interface). For virtualized network elements, the SMO Framework 405 may be configured to interact with a cloud computing platform (such as an open cloud (O-Cloud) 490) to perform network element life cycle management (such as to instantiate virtualized network elements) via a cloud computing platform interface (such as an O2 interface). Such virtualized network elements can include, but are not limited to, CUs 410, DUs 430, RUs 440 and Near-RT RICs 425. In some implementations, the SMO Framework 405 can communicate with a hardware aspect of a 4G RAN, such as an open eNB (O-eNB) 411, via an O1 interface. Additionally, in some implementations, the SMO Framework 405 can communicate directly with one or more RUs 440 via an O1 interface. The SMO Framework 405 also may include a Non-RT RIC 415 configured to support functionality of the SMO Framework 405.

The Non-RT RIC 415 may be configured to include a logical function that enables non-real-time control and optimization of RAN elements and resources, Artificial Intelligence/Machine Learning (AI/ML) workflows including model training and updates, or policy-based guidance of applications/features in the Near-RT RIC 425. The Non-RT RIC 415 may be coupled to or communicate with (such as via an A1 interface) the Near-RT RIC 425. The Near-RT RIC 425 may be configured to include a logical function that enables near-real-time control and optimization of RAN elements and resources via data collection and actions over an interface (such as via an E2 interface) connecting one or more CUs 410, one or more DUs 430, or both, as well as an O-eNB, with the Near-RT RIC 425.

In some implementations, to generate AI/ML models to be deployed in the Near-RT RIC 425, the Non-RT RIC 415 may receive parameters or external enrichment information from external servers. Such information may be utilized by the Near-RT RIC 425 and may be received at the SMO Framework 405 or the Non-RT RIC 415 from non-network data sources or from network functions. In some examples, the Non-RT RIC 415 or the Near-RT RIC 425 may be configured to tune RAN behavior or performance. For example, the Non-RT RIC 415 may monitor long-term trends and patterns for performance and employ AI/ML models to perform corrective actions through the SMO Framework 405 (such as reconfiguration via 01) or via creation of RAN management policies (such as A1 policies).

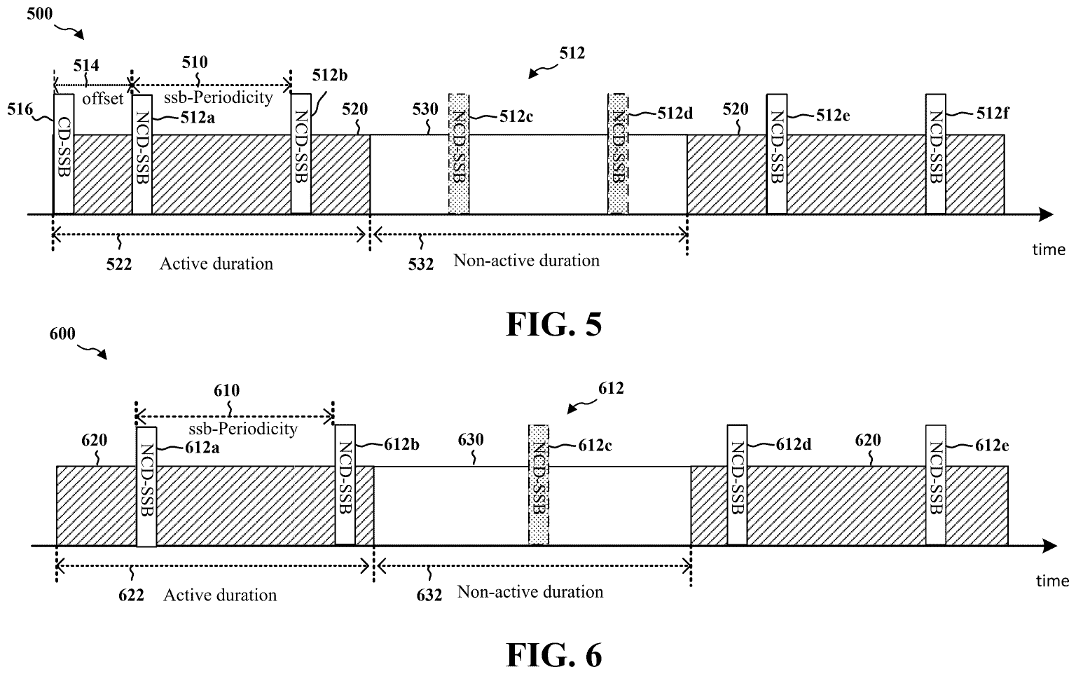

FIG. 5 is a timing diagram 500 illustrating an example relationship between a NCD-SSB configuration and a DTX configuration. The NCD-SSB configuration may be defined by a periodicity and an offset. The periodicity 510 may define a time period between transmissions of the NCD-SSB 512 (e.g., NCD-SSBs 512a-512f). In some implementations, the periodicity 510 may be selected from a set of enumerated values such as {5 ms, 10 ms, 20 ms, 40 ms, 80 ms, 160 ms}. The periodicity of the NCD-SSB 512 may be greater than or equal to a periodicity of the cell-defining SSB. The offset 514 is an offset between the cell-defining SSB 516 and the NCD-SSB 512.

The DTX configuration may define an active duration 522 of an active period 520 and a non-active duration 532 of a non-active period 530. The network node may alternate between the active period 520 and the non-active period 530. Generally, the network node does not transmit signals to which the DTX configuration applies during the non-active period 530. In contrast, the network node may transmit the cell-defining SSB 516 regardless of whether in the active period 520 or the non-active period 530.

The DTX configuration may or may not align with the NCD-SSB configuration. In the illustrated example of FIG. 5, the NCD-SSB periodicity 510 is half of the active duration 522. For example, the NCD-SSB periodicity 510 may be 40 ms and the active duration 522 may be 80 ms. The non-active duration 532 is the same as the active duration 522. Accordingly, the DTX configuration repeats every four NCD-SSBs 512.

FIG. 6 is a timing diagram 600 illustrating an example relationship between an NCD-SSB configuration and a DTX configuration. In this example, the active duration 622 and the non-active duration 632 are not a multiple of the NCD-SSB periodicity 610. For example, the NCD-SSB periodicity 610 may be 40 ms and the active duration 622 may be 64 ms. In this case, the timing for the NCD-SSB 612 (e.g., NCD-SSBs 612a-612e) may change with respect to each active period 620 or non-active period 630. Further, the number of NCD-SSBs 612 within each active period 620 or non-active period 630 may vary. However, the timing pattern between the NCD-SSB 612 and the DTX configuration may repeat after a number of DTX cycles. For instance, the pattern may repeat after 5 DTX cycles, where the total duration of the DTX cycles is a common multiple of the periodicity 610.

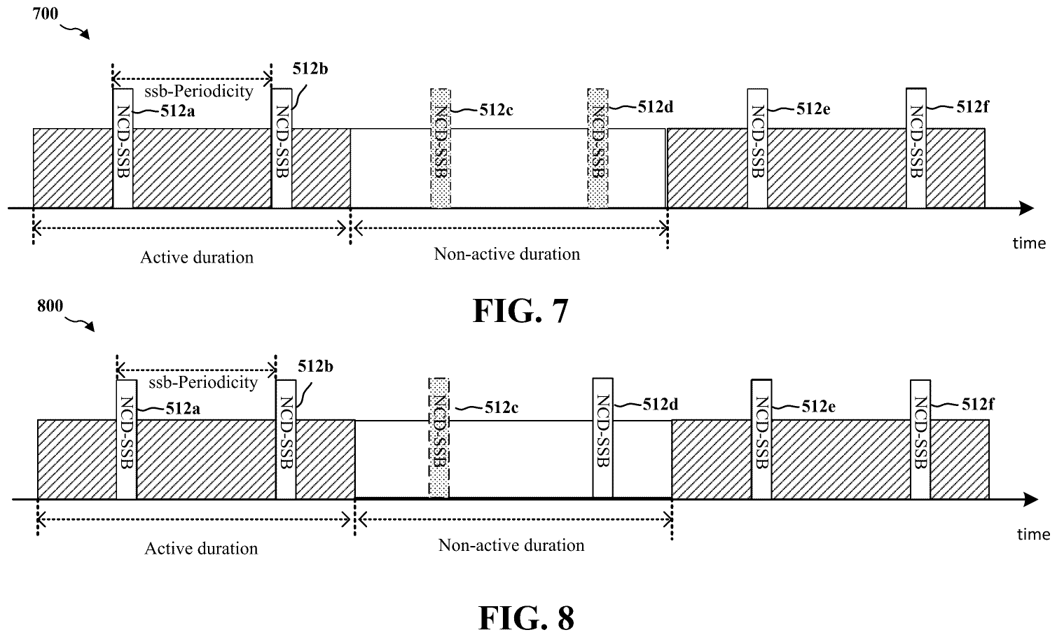

FIG. 7 is a timing diagram 700 illustrating an example of dropping transmissions of NCD-SSB during a non-active period 530. In some implementations, a network node may drop all transmissions of the NCD-SSB 512, that occur during the non-active period 530. The network node may apply a rule to drop all transmissions within the non-active period 530. For example, the network node may drop transmissions of NCD-SSBs 512c and 512d.

In some implementations, the network node may not transmit a DTX configuration to UEs. A UE may attempt to receive or measure a transmission of NCD-SSB 512c that has been dropped. The reception or measurement may fail, which may consume unnecessary power at the UE. In some implementations, the network node may transmit the DTX configuration, which may allow the UE to apply the same rule as the network node to determine which transmissions of NCD-SSB 512 are dropped.

FIG. 8 is a timing diagram 800 illustrating an example of dropping transmissions according to a muting pattern. The network node may be configured to drop transmissions within the non-active period 530 based on a muting pattern. For example, a network node may drop transmissions of NCD-SSBs 512 that are early in the non-active period 530, but transmit NCD-SSBs 512 that are later in the non-active period 530. For instance, the later transmissions may be used for channel estimation or measurements for the UE to receive other transmissions during the active period 520. In some implementations, a network node may follow a rule to not drop a last transmission of NCD-SSB 512 within the non-active period 530 or to not drop a NCD-SSB transmission that is within a threshold of the next active period 520. As illustrated, the network node may drop the transmission of NCD-SSB 512c, but not drop (i.e., transmit) the transmission of NCD-SSB 512d.

In some implementations, the network node may indicate a muting pattern to a UE 104 to allow the UE to determine which transmissions of NCD-SSB 512 to monitor. The indication of the muting pattern may be a bit string where each bit represents a transmission of NCD-SSB 512 until the pattern repeats. For example, referring back to the example in FIG. 7, the muting pattern may be indicated as “1100” to indicate that NCD-SSBs 512a and 512b are transmitted and NCD-SSBs 512c and 512d are dropped, then the pattern repeats. Similarly, the muting pattern in FIG. 8 may be indicated as “1101” to indicate that NCD-SSBs 512a, 512b are transmitted, NCD-SSB 512c is dropped, and NCD-SSB 512d is transmitted, then the pattern repeats. The indication of a muting pattern may allow the network the flexibility to achieve a variety of goals and does not require an indication of a rule used by the network node to determine which NCD-SSBs to drop.

Referring back to the example relationship in FIG. 6, a muting pattern may be used to indicate the dropped NCD-SSBs. For instance, if the network node follows a rule to drop all NCD-SSBs during the non-active period 630, the muting pattern may be indicated as “1101101100100100.” As another example, if the network node follows a rule to transmit only the last NCD-SSB 512 during the non-active period 630, the muting pattern may be indicated as “11111111010101.” Accordingly, transmitting the indication of the muting pattern as a bit string may efficiently signal which NCD-SSBs are transmitted and which NCD-SSBs are dropped. For instance, the muting pattern may be transmitted as system information, an information element of an RRC configuration, or a media access control (MAC) control element (CE).

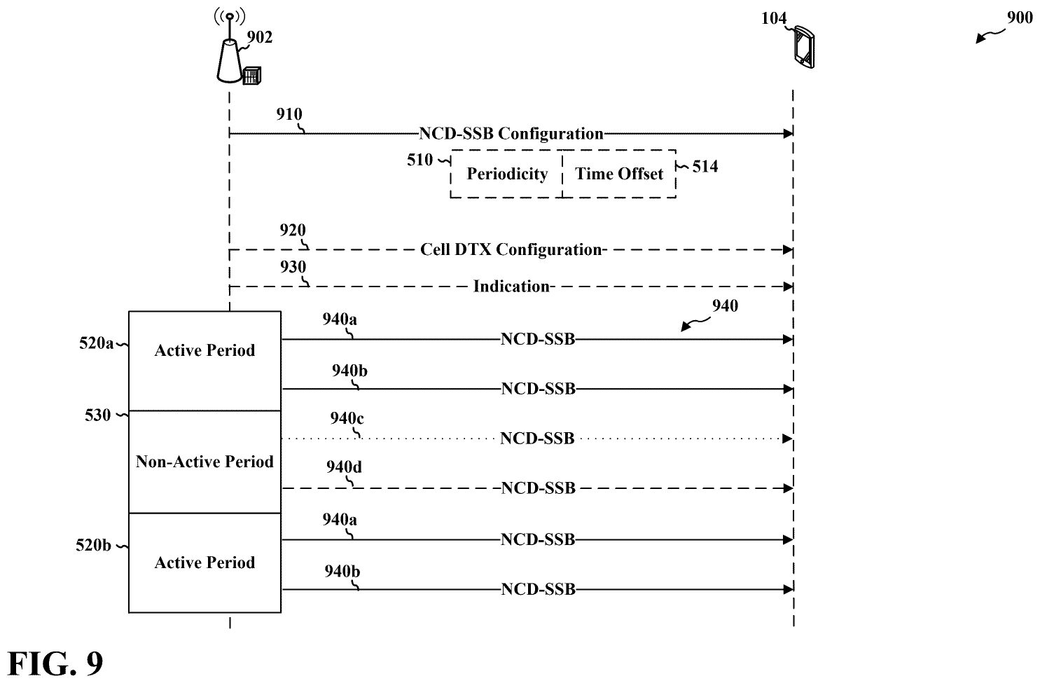

FIG. 9 is a message diagram 900 illustrating various messages for applying a DTX configuration to NDC-SSB transmissions. For example, a network node 902 may transmit NCD-SSBs according to a NCD-SSB configuration and a DTX configuration. The network node 902 and a UE 104 may determine which NCD-SSBs are transmitted or dropped based on one or more of: the NCD-SSB configuration, the cell DTX configuration, or the muting pattern.

The network node 902 transmits a NCD-SSB configuration 910 to the UE 104. For example, the NCD-SSB configuration 910 may be an RRC configuration message that the network node 902 transmits when a UE 104 accesses a RedCap-specific BWP configured with a NCD-SSB. The NCD-SSB configuration 910 may include a periodicity 510 and a time offset 514. In some implementations, if the NCD-SSB configuration 910 does not explicitly include an information element for the periodicity 510 or the time offset 514, the NCD-SSB configuration 910 may implicitly indicate that the periodicity 510 is the periodicity of the cell defining SSB and/or the time offset 514 is zero. In some implementations, the NCD-SSB configuration 910 may include a information element (e.g., “absoluteFrequencySSB”) that indicates a frequency of the NCD-SSB.

In some implementations, the network node 902 may optionally transmit a cell DTX configuration 920. For example, the cell DTX configuration may be an RRC configuration message. The cell DTX configuration 920 may include an active duration 522 for an active period 520 and a non-active duration 532 for a non-active period 530.

In some implementations, the network node 902 may optionally transmit an indication 930 of a muting pattern. For example, the indication 930 may be an RRC information element or a MAC-CE. The indication 930 may be a bit string indicating a status of each transmission of the NCD-SSB 940 until the muting pattern repeats. For instance, in the illustrated example, the muting pattern may be indicated as “1101.”

The network node 902 may transmit the NCD-SSB 940 based on the NCD-SSB configuration 910 and the DTX configuration 920. For instance, the network node 902 may transmit the NCD-SSB 940a and 940b during a first active period 520a, drop the NCD-SSB 940c during the non-active period 530, and optionally transmit the NCD-SSB 940d during the non-active period 530 based on the muting pattern. The network node 902 may repeat the pattern beginning in a second active period 520b.

The UE 104 may receive the NCD-SSB configuration 910. The UE 104 may optionally receive one or both of the DTX configuration 920 or the indication 930. The UE 104 may then receive at least one of the transmitted NCD-SSBs 940a, 940b, or 940d based at least in part on the muting pattern. For instance, if the UE receives the DTX configuration 920, the UE 104 may assume the NCD-SSB 940d is dropped during the non-active period 530. The UE 104 may refrain from receiving the NCD-SSB 940c and the NCD-SSB 940d that are dropped. If the UE 104 receives the indication 930, the UE 104 may determine based on the muting pattern that the NCD-SSB 940d is not dropped and receive the NCD-SSB 940d prior to the active period 520b.

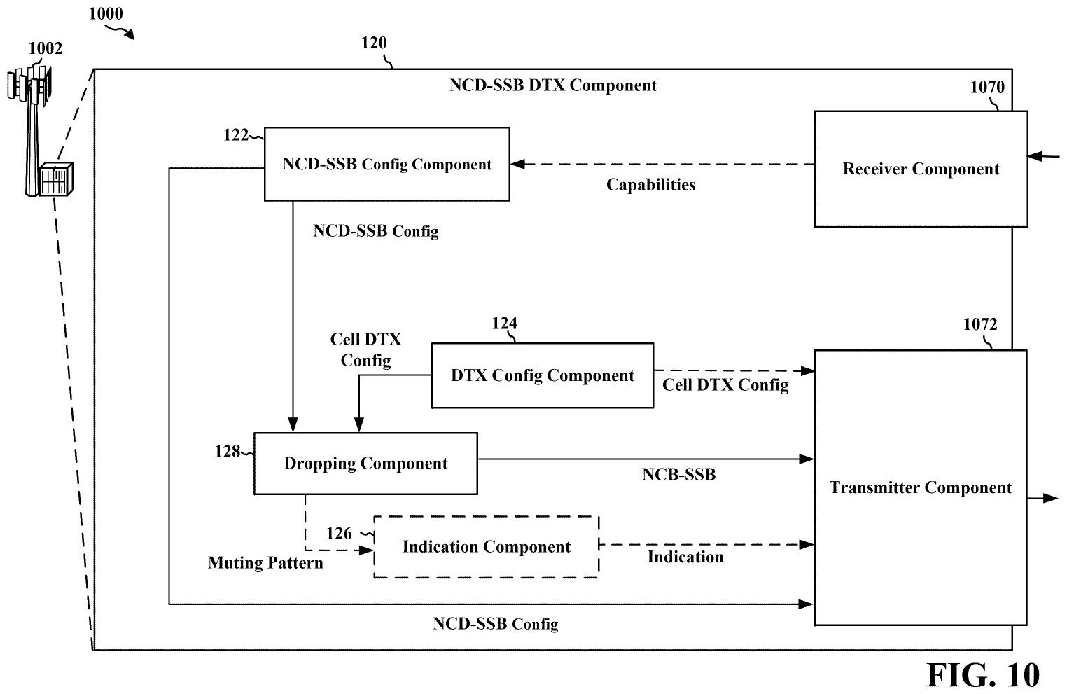

FIG. 10 is a conceptual data flow diagram 1000 illustrating the data flow between different means/components in an example network node 1002, which may be an example of the base station 102 (FIG. 1) including the NCD-SSB DTX component 120 or the network node 902. The NCD-SSB DTX component 120 may be implemented by the memory 376 and the TX processor 316, the RX processor 370, and/or the controller/processor 375 of FIG. 3. For example, the memory 376 may store executable instructions defining the NCD-SSB DTX component 120 and the TX processor 316, the RX processor 370, and/or the controller/processor 375 may execute the instructions.

The base station 102 may include a receiver component 1070, which may include, for example, a radio frequency (RF) receiver for receiving the signals described herein. The base station 102 may include a transmitter component 1072, which may include, for example, an RF transmitter for transmitting the signals described herein. In an aspect, the receiver component 1070 and the transmitter component 1072 may be co-located in a transceiver such as illustrated by the TX/RX 318 in FIG. 3.

As discussed with respect to FIG. 1, the NCD-SSB DTX component 120 includes the NCD-SSB config component 122, the DTX config component 124, and the dropping component 128. The NCD-SSB DTX component 120 may optionally include the indication component 126.

The receiver component 1070 may receive UL signals from the UE 104 such as a UE capability message. The receiver component 1070 may output the UE capabilities to the NCD-SSB config component 122. For instance, the UE capabilities may indicate that the UE is a RedCap UE.

The NCD-SSB config component 122 is configured to transmit a configuration of a NCD-SSB having a periodicity and a time offset transmit, to a UE 104. For instance, the NCD-SSB config component 122 may transmit the NCD-SSB configuration 910 as an RRC message via the transmitter component 1072. The NCD-SSB config component 122 may also provide the NCD-SSB configuration to the dropping component 128.

The DTX config component 124 is configured to determine a configuration of an active period and a non-active period for a cell DTX configuration. For example, the DTX config component 124 may transmit the cell DTX configuration 920 as an RRC message via the transmitter component 1072. The DTX config component 124 may provide the cell DTX configuration to the dropping component 128.

The dropping component 128 is configured to drop at least one transmission of the NCD-SSB when the periodicity and the time offset indicate that the transmission is within the non-active period for the cell DTX configuration. For instance, the dropping component 128 may receive the NCD-SSB configuration from the NCD-SSB config component 122 and receive the cell DTX configuration from the DTX config component 124. The dropping component 128 may determine a muting pattern based on the NCD-SSB configuration, the cell DTX configuration, and a rule. The dropping component 128 may use the muting pattern to determine at least one NCD-SSB transmission to drop. The dropping component 128 may allow the other NCD-SSB transmissions to proceed to the transmitter component 1072 for transmission. In some implementations, the dropping component 128 may output the muting pattern to the indication component 126.

The optional indication component 126 may be configured to transmit an indication of a muting pattern that indicates which transmissions of the NCD-SSB are dropped. For example, the indication component 126 may receive the muting pattern from the dropping component 128. The indication component 128 may transmit the indication 930 as system information, a RRC information element, or a MAC-CE via the transmitter component 1072.

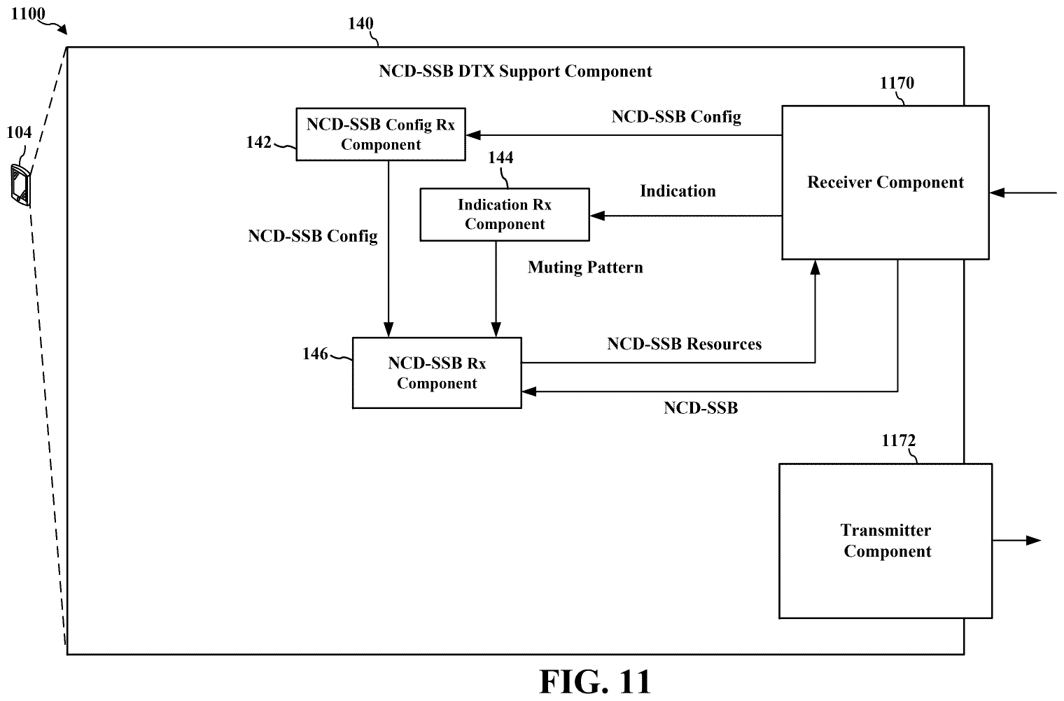

FIG. 11 is a conceptual data flow diagram 1100 illustrating the data flow between different means/components in an example UE 104, which may be an example of the UE 104 (FIG. 1) and include the NCD-SSB DTX support component 140. The NCD-SSB DTX support component 140 may be implemented by the memory 360 and the TX processor 368, the RX processor 356, and/or the controller/processor 359. For example, the memory 360 may store executable instructions defining the NCD-SSB DTX support component 140 and the TX processor 368, the RX processor 356, and/or the controller/processor 359 may execute the instructions.

The UE 104 may include a receiver component 1170, which may include, for example, a RF receiver for receiving the signals described herein. The UE 104 may include a transmitter component 1172, which may include, for example, an RF transmitter for transmitting the signals described herein. In an aspect, the receiver component 1170 and the transmitter component 1172 may co-located in a transceiver such as the TX/RX 352 in FIG. 3.

As discussed with respect to FIG. 1, the NCD-SSB DTX support component 140 includes the NCD-SSB config Rx component 142, the indication Rx component 144, and the NCD-SSB Rx component 146.

The receiver component 1170 may receive DL signals described herein such as the NCD-SSB configuration 910, the DTX configuration 920, the indication 930, and the NCD-SSB 940. The receiver component 1170 may output the NCD-SSB configuration 910 to the NCD-SSB config Rx component 142. The receiver component 1170 may output the DTX configuration 920 and/or the indication 930 to the indication Rx component 144. The receiver component 1170 may output the NCD-SSB 940 to the NCD-SSB Rx component 146.

The NCD-SSB config Rx component 142 is configured to receive a configuration of a NCD-SSB having a periodicity and a time offset. For example, the NCD-SSB config Rx component 142 may receive the NCD-SSB configuration 910 from the receiver component 1170 as an RRC message including information elements. The NCD-SSB config Rx component 142 may determine values of the periodicity 510 and the time offset 514. The NCD-SSB config Rx component 142 may output the NCD-SSB configuration to the NCD-SSB Rx component 146.

The indication Rx component 144 is configured to receive an indication of a muting pattern that indicates which transmissions of the NCD-SSB are dropped. For example, the indication Rx component 144 may receive the indication 930 via the receiver component 1170 as an RRC information element or a MAC-CE. The indication Rx component 144 may determine a muting pattern included in the indication, for example, as a bit string. In some implementations, the indication Rx component 144 may receive the cell DTX configuration 920. The indication Rx component 144 may determine The indication Rx component 144 may provide the muting pattern to the NCD-SSB Rx component 146.

The NCD-SSB Rx component 146 is configured to receive at least one transmission of the NCD-SSB based at least in part on the muting pattern. For example, the NCD-SSB Rx component 146 may receive the NCD-SSB configuration from the NCD-SSB config Rx component 142 and receive the muting pattern from the indication Rx component 144. The NCD-SSB Rx component 146 may determine NCD-SSB resources on which the NCD-SSB 940 is dropped or determine NCD-SSB resources on which the NCD-SSB 940 is transmitted based on the NCD-SSB configuration and the muting pattern. In some implementations, the NCD-SSB Rx component 146 may consider the cell DTX configuration when determining whether to receive a NCD-SSB. In some implementations, the NCD-SSB configuration may provide the NCD-SSB resources for at least one transmission of the NCD-SSB that is not dropped to the receiver component 1170. The NCD-SSB Rx component 146 may receive the signal received on the NCD-SSB resources from the receiver component 1170. The NCD-SSB Rx component 146 may perform operations such as obtaining sync, measurements, and/or RLM based on the received NCD-SSB 940. In some implementations, the NCD-SSB Rx component 146 may refrain from receiving a NCD-SSB transmission that has been dropped. For example, the NCD-SSB Rx component 146 may not indicate the NCD-SSB resources to the receiver component 1170, may power down the receiver component 1170, or may not perform operations on the received signal.

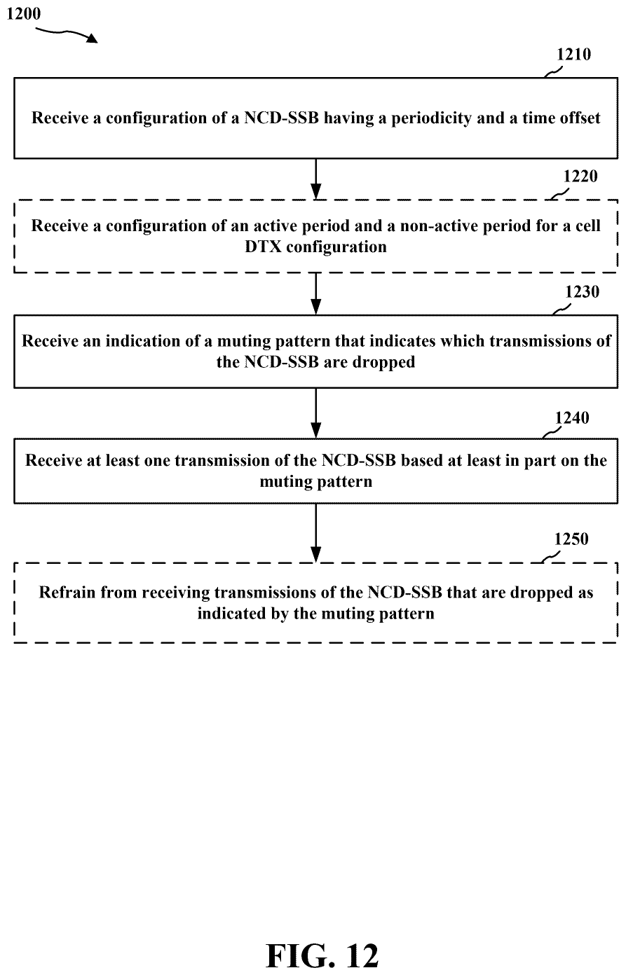

FIG. 12 is a flowchart of an example method 1200 for a UE 104 to receive a NCD-SSB when a cell DTX configuration is applicable to NCD-SSB transmission. The method 1200 may be performed by a UE (such as the UE 104, which may include the memory 360 and which may be the entire UE 104 or a component of the UE 104 such as the NCD-SSB DTX support component 140, TX processor 368, the RX processor 356, or the controller/processor 359). The method 1200 may be performed by the NCD-SSB DTX support component 140 in communication with the NCD-SSB DTX component 120 of one or more network nodes 902 (e.g., base station 102). Optional blocks are shown with dashed lines.

At block 1210, the method 1200 includes receiving a configuration of a NCD-SSB having a periodicity and a time offset. In some implementations, for example, the UE 104, the RX processor 356, or the controller/processor 359 may execute the NCD-SSB DTX support component 140 or the NCD-SSB config Rx component 142 to receive a configuration 910 of a NCD-SSB having a periodicity 510 and a time offset 514. Accordingly, the UE 104, the RX processor 356, or the controller/processor 359 executing the NCD-SSB DTX support component 140 or the NCD-SSB config Rx component 142 may provide means for receiving a configuration of a NCD-SSB having a periodicity and a time offset.

At block 1220, the method 1200 may optionally include receiving a configuration of an active period and a non-active period for a cell DTX configuration. In some implementations, for example, the UE 104, the RX processor 356 or the controller/processor 359 may execute the NCD-SSB DTX support component 140 or the indication Rx component 144 to receive the DTX configuration 920 of an active period 520 and a non-active period 530 for a cell DTX configuration. In some implementations, the transmissions of the NCD-SSB that are dropped include all transmissions within a non-active period 530 of the cell DTX configuration 920. Accordingly, the UE 104, the RX processor 356, or the controller/processor 359 executing the NCD-SSB DTX support component 140 or the indication Rx component 144 may provide means for receiving a configuration of an active period and a non-active period for a cell DTX configuration.

At block 1230, the method 1200 includes receiving an indication of a muting pattern that indicates which transmissions of the NCD-SSB are dropped. In some implementations, for example, the UE 104, the RX processor 356, or the controller/processor 359 may execute the NCD-SSB DTX support component 140 or the indication Rx component 144 to receive the indication 930 of a muting pattern that indicates which transmissions of the NCD-SSB 940 are dropped. In some implementations, the indication of the muting pattern is a bit string indicating a status of each transmission of the NCD-SSB until the muting pattern repeats. In some implementations, the muting pattern indicates that at least one transmission of the NCD-SSB during a non-active period 530 for a cell DTX configuration is not dropped. For instance, the at least one transmission of the NCD-SSB during the non-active period for the cell DTX configuration that is not dropped may be within a threshold time of a start of an active period 520 of the cell DTX configuration. Accordingly, the UE 104, the RX processor 356, or the controller/processor 359 executing the NCD-SSB DTX support component 140 or the indication Rx component 144 may provide means for receiving an indication of a muting pattern that indicates which transmissions of the NCD-SSB are dropped.

At block 1240, the method 1200 includes receiving at least one transmission of the NCD-SSB based at least in part on the muting pattern. In some implementations, for example, the UE 104, the RX processor 356, the TX processor 368, or the controller/processor 359 may execute the NCD-SSB DTX support component 140 or the NCD-SSB Rx component 146 to receive at least one transmission of the NCD-SSB based at least in part on the muting pattern. For example, the NCD-SSB Rx component 146 may apply the muting pattern to the NCD-SSB configuration to determine which transmissions of the NCD-SSB are dropped. The NCD-SSB Rx component 146 may determine to receive a transmission of the NCD-SSB that is not dropped. In some implementations, the NCD-SSB Rx component 146 may select a transmission of the NCD-SSB based on other factors such as a DTX/DRX cycle of the UE or whether the UE has data to transmit. In view of the foregoing, the UE 104, the RX processor 356 or the controller/processor 359 executing the NCD-SSB DTX support component 140 or the NCD-SSB Rx component 146 may provide means for receiving at least one transmission of the NCD-SSB based at least in part on the muting pattern.

At block 1250, the method 1200 includes refraining from receiving transmissions of the NCD-SSB that are dropped as indicated by the muting pattern. In some implementations, for example, the UE 104, the RX processor 356, the TX processor 368, or the controller/processor 359 may execute the NCD-SSB DTX support component 140 or the NCD-SSB Rx component 146 to refrain from receiving transmissions of the NCD-SSB that are dropped as indicated by the muting pattern. For example, the NCD-SSB Rx component 146 may power down a receiver or receive chain or omit an operation on a signal received on NCD-SSB resources when the NCD-SSB is dropped. Accordingly, the UE 104, the RX processor 356 or the controller/processor 359 executing the NCD-SSB DTX support component 140 or the NCD-SSB Rx component 146 may provide means for refraining from receiving transmissions of the NCD-SSB that are dropped as indicated by the muting pattern.

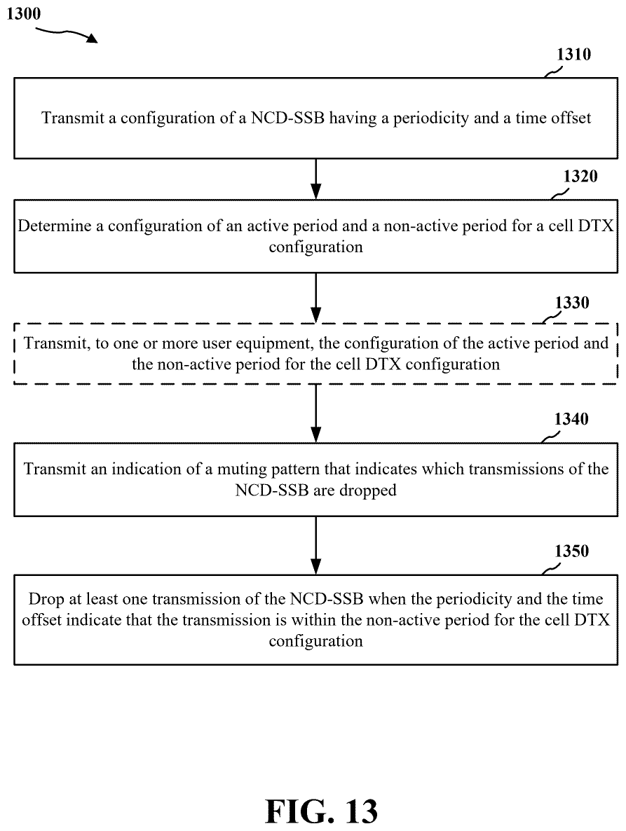

FIG. 13 is a flowchart of an example method 1300 for a network node (e.g., a base station, gNB, or TRP) to transmit a NCD-SSB based on a NCD-SSB configuration and a cell DTX configuration. The method 1300 may be performed by a network node (such as the base station 102, which may include the memory 376 and which may be the entire base station 102 or a component of the base station 102 such as the NCD-SSB DTX component 120, the TX processor 316, the RX processor 370, or the controller/processor 375). The method 1300 may be performed by the NCD-SSB DTX component 120 in communication with the NCD-SSB DTX support component 140 of the UE 104.

At block 1310, the method 1300 includes transmitting a configuration of a NCD-SSB having a periodicity and a time offset. In some implementations, for example, the base station 102, the TX processor 316, or the controller/processor 375 may execute the NCD-SSB DTX component 120 or the NCD-SSB config component 122 to transmit the configuration 910 of a NCD-SSB having a periodicity 510 and a time offset 514. Accordingly, the base station 102, the TX processor 316, or the controller/processor 375 executing the NCD-SSB DTX component 120 or the NCD-SSB config component 122 may provide means for transmitting a configuration of a NCD-SSB having a periodicity and a time offset.

At block 1320, the method 1300 includes determining a configuration of an active period and a non-active period for a cell DTX configuration. In some implementations, for example, the base station 102, the TX processor 316, or the controller/processor 375 may execute the NCD-SSB DTX component 120 or DTX config component 124 to determine the configuration 920 of an active period 520 and a non-active period 530 for a cell DTX configuration. Accordingly, the the base station 102, the TX processor 316, or the controller/processor 375 executing the NCD-SSB DTX component 120 or the DTX config component 124 may provide means for determining a configuration of an active period and a non-active period for a cell DTX configuration.

At block 1330, the method 1300 may optionally include transmitting, to one or more user equipment, the configuration of the active period and the non-active period for the cell DTX configuration. In some implementations, for example, the base station 102, the TX processor 316, or the controller/processor 375 may execute the NCD-SSB DTX component 120 or DTX config component 124 to transmit, to one or more UEs 104, the configuration 920 of the active period 520 and the non-active period 530 for the cell DTX configuration. Accordingly, the base station 102, the TX processor 316, or the controller/processor 375 executing the NCD-SSB DTX component 120 or the DTX config component 124 may provide means for transmitting, to one or more user equipment, the configuration of the active period and the non-active period for the cell DTX configuration.

At block 1340, the method 1300 includes transmitting an indication of a muting pattern that indicates which transmissions of the NCD-SSB are dropped. In some implementations, for example, the base station 102, the TX processor 316, or the controller/processor 375 may execute the NCD-SSB DTX component 120 or the indication component 126 to transmit the indication 930 of a muting pattern that indicates which transmissions of the NCD-SSB 940 are dropped. In some implementations, the indication of the muting pattern is a bit string indicating a status of each transmission of the NCD-SSB until the muting pattern repeats. In some implementations, the muting pattern indicates that at least one transmission of the NCD-SSB during the non-active period for the cell DTX configuration is not dropped. For instance, the at least one transmission of the NCD-SSB during the non-active period for the cell DTX configuration that is not dropped may be within a threshold time of a start of the active period 520. In some implementations, the muting pattern indicates that all transmissions within the non-active period 530 are dropped. Accordingly, the base station 102, the TX processor 316, or the controller/processor 375 executing the NCD-SSB DTX component 120 or the indication component 126 may provide means for transmitting an indication of a muting pattern that indicates which transmissions of the NCD-SSB are dropped.

At block 1350, the method 1300 includes dropping at least one transmission of the NCD-SSB when the periodicity and the time offset indicate that the transmission is within the non-active period for the cell DTX configuration. In some implementations, for example, the base station 102, the TX processor 316 or the controller/processor 375 may execute the NCD-SSB DTX component 120 or the dropping component 128 to drop at least one transmission of the NCD-SSB (e.g., NCD-SSB 512c) when the periodicity 510 and the time offset 514 indicate that the transmission is within the non-active period 530 for the cell DTX configuration. In some implementations, the at least one transmission of the NCD-SSB that is dropped includes all transmissions within the non-active period. In view of the foregoing, the base station 102, the TX processor 316, or the controller/processor 375 executing the NCD-SSB DTX component 120 or the dropping component 128 may provide means for dropping at least one transmission of the NCD-SSB when the periodicity and the time offset indicate that the transmission is within the non-active period for the cell DTX configuration.

The following numbered clauses provide an overview of aspects of the present disclosure:
Clause 1. A method of wireless communications at a user equipment (UE), comprising: receiving a configuration of a non-cell defining (NCD) synchronization signal block (SSB) having a periodicity and a time offset; receiving an indication of a muting pattern that indicates which transmissions of the NCD-SSB are dropped; receiving at least one transmission of the NCD-SSB based at least in part on the muting pattern.
Clause 2. The method of clause 1, further comprising refraining from receiving transmissions of the NCD-SSB that are dropped as indicated by the muting pattern.
Clause 3. The method of clause 1 or 2, wherein the transmissions of the NCD-SSB that are dropped include all transmissions within a non-active period of a cell discontinuous transmission (DTX) configuration.
Clause 4. The method of clause 1 or 2, wherein the muting pattern indicates that at least one transmission of the NCD-SSB during a non-active period for a cell DTX configuration is not dropped.
Clause 5. The method of clause 4, wherein the at least one transmission of the NCD-SSB during the non-active period for the cell DTX configuration is within a threshold time of a start of an active period of the cell DTX configuration.
Clause 6. The method of any of clauses 1-5, wherein the indication of the muting pattern is a bit string indicating a status of each transmission of the NCD-SSB until the muting pattern repeats.
Clause 7. The method of any of clauses 1-6, further comprising receiving a configuration of an active period and a non-active period for a cell DTX configuration.
Clause 8. A method of wireless communications at a network node, comprising: transmitting a configuration of a non-cell defining (NCD) synchronization signal block (SSB) having a periodicity and a time offset; determining a configuration of an active period and a non-active period for a cell discontinuous transmission (DTX) configuration; and dropping at least one transmission of the NCD-SSB when the periodicity and the time offset indicate that the transmission is within the non-active period for the cell DTX configuration.
Clause 9. The method of clause 8, wherein the at least one transmission of the NCD-SSB includes all transmissions within the non-active period.
Clause 10. The method of clause 8, further comprising transmitting an indication of a muting pattern that indicates which transmissions of the NCD-SSB are dropped.
Clause 11. The method of clause 10, wherein the muting pattern indicates that at least one transmission of the NCD-SSB during the non-active period for the cell DTX configuration is not dropped.
Clause 12. The method of clause 11, wherein the at least one transmission of the NCD-SSB during the non-active period for the cell DTX configuration is within a threshold time of a start of the active period.
Clause 13. The method of clause 10, wherein the muting pattern indicates that all transmissions within the non-active period are dropped.
Clause 14. The method of any of clauses 10-13, wherein the indication of the muting pattern is a bit string indicating a status of each transmission of the NCD-SSB until the muting pattern repeats.
Clause 15. The method of any of clauses 8-14, further comprising transmitting, to one or more user equipment, the configuration of the active period and the non-active period for the cell DTX configuration.
Clause 16. An apparatus for wireless communication at a user equipment (UE), comprising: one or more memories, individually or in combination, storing computer-executable instructions; and one or more processors, individually or in combination, configured to execute the instructions to: receive a configuration of a non-cell defining (NCD) synchronization signal block (SSB) having a periodicity and a time offset; receive an indication of a muting pattern that indicates which transmissions of the NCD-SSB are dropped; receive at least one transmission of the NCD-SSB based at least in part on the muting pattern.
Clause 17. The apparatus of clause 16, wherein the one or more processors, individually or in combination, are configured to refrain from receiving transmissions of the NCD-SSB that are dropped as indicated by the muting pattern.
Clause 18. The apparatus of clause 16 or 17, wherein the transmissions of the NCD-SSB that are dropped include all transmissions within a non-active period of a cell discontinuous transmission (DTX) configuration.
Clause 19. The apparatus of clause 16 or 17, wherein the muting pattern indicates that at least one transmission of the NCD-SSB during a non-active period for a cell DTX configuration is not dropped.
Clause 20. The apparatus of clause 19, wherein the at least one transmission of the NCD-SSB during the non-active period for the cell DTX configuration is within a threshold time of a start of an active period of the cell DTX configuration.
Clause 21. The apparatus of any of clauses 17-20, wherein the indication of the muting pattern is a bit string indicating a status of each transmission of the NCD-SSB until the muting pattern repeats.
Clause 22. The apparatus of any of clauses 17-21, wherein the one or more processors, individually or in combination, are configured to receive a configuration of an active period and a non-active period for a cell DTX configuration.
Clause 23. An apparatus for wireless communications at a network node, comprising: one or more memories, individually or in combination, storing computer-executable instructions; and one or more processors, individually or in combination, configured to execute the instructions to: transmit a configuration of a non-cell defining (NCD) synchronization signal block (SSB) having a periodicity and a time offset; determine a configuration of an active period and a non-active period for a cell discontinuous transmission (DTX) configuration; and drop at least one transmission of the NCD-SSB when the periodicity and the time offset indicate that the transmission is within the non-active period for the cell DTX configuration.
Clause 24. The apparatus of clause 23, wherein the at least one transmission of the NCD-SSB includes all transmissions within the non-active period.
Clause 25. The apparatus of clause 23 or 24, wherein the one or more processors, individually or in combination, are configured to transmit an indication of a muting pattern that indicates which transmissions of the NCD-SSB are dropped.
Clause 26. The apparatus of clause 25, wherein the muting pattern indicates that at least one transmission of the NCD-SSB during the non-active period for the cell DTX configuration is not dropped.
Clause 27. The apparatus of clause 26, wherein the at least one transmission of the NCD-SSB during the non-active period for the cell DTX configuration is within a threshold time of a start of the active period.
Clause 28. The apparatus of clause 25, wherein the muting pattern indicates that all transmissions within the non-active period are dropped.
Clause 29. The apparatus of any of clauses 25-28, wherein the indication of the muting pattern is a bit string indicating a status of each transmission of the NCD-SSB until the muting pattern repeats.
Clause 30. The apparatus of any of clauses 23-29, wherein the one or more processors, individually or in combination, are configured to transmit, to one or more user equipment, the configuration of the active period and the non-active period for the cell DTX configuration.
Clause 31. An apparatus comprising means for performing the method of any of Clauses 1-7.
Clause 32. A non-transitory computer-readable medium storing computer-executable instructions that when executed by a processor of a user equipment (UE) cause the UE to perform the method of any of Clauses 1-7.
Clause 33. An apparatus comprising means for performing the method of any of Clauses 8-15.
Clause 34. A non-transitory computer-readable medium storing computer-executable instructions that when executed by a processor of a network node cause the network node to perform the method of any of Clauses 8-15.

As used herein, a phrase referring to “at least one of” a list of items refers to any combination of those items, including single members. As an example, “at least one of: a, b, or c” is intended to cover: a, b, c, a-b, a-c, b-c, and a-b-c.

The various illustrative logics, logical blocks, modules, circuits and algorithm processes described in connection with the implementations disclosed herein may be implemented as electronic hardware, computer software, or combinations of both. The interchangeability of hardware and software has been described generally, in terms of functionality, and illustrated in the various illustrative components, blocks, modules, circuits and processes described above. Whether such functionality is implemented in hardware or software depends upon the particular application and design constraints imposed on the overall system.

The hardware and data processing apparatus used to implement the various illustrative logics, logical blocks, modules and circuits described in connection with the aspects disclosed herein may be implemented or performed with a general purpose single- or multi-chip processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general purpose processor may be a microprocessor, or any conventional processor, controller, microcontroller, or state machine. A processor also may be implemented as a combination of computing devices, such as a combination of a DSP and a microprocessor, a plurality of microprocessors, one or more microprocessors in conjunction with a DSP core, or any other such configuration. In some implementations, particular processes and methods may be performed by circuitry that is specific to a given function.

In one or more aspects, the functions described may be implemented in hardware, digital electronic circuitry, computer software, firmware, including the structures disclosed in this specification and their structural equivalents thereof, or in any combination thereof. Implementations of the subject matter described in this specification also can be implemented as one or more computer programs, i.e., one or more modules of computer program instructions, encoded on a computer storage media for execution by, or to control the operation of, data processing apparatus.

If implemented in software, the functions may be stored on or transmitted over as one or more instructions or code on a computer-readable medium. The processes of a method or algorithm disclosed herein may be implemented in a processor-executable software module which may reside on a computer-readable medium. Computer-readable media includes both computer storage media and communication media including any medium that can be enabled to transfer a computer program from one place to another. A storage media may be any available media that may be accessed by a computer. By way of example, and not limitation, such computer-readable media may include RAM, ROM, EEPROM, CD-ROM or other optical disk storage, magnetic disk storage or other magnetic storage devices, or any other medium that may be used to store desired program code in the form of instructions or data structures and that may be accessed by a computer. Also, any connection can be properly termed a computer-readable medium. Disk and disc, as used herein, includes compact disc (CD), laser disc, optical disc, digital versatile disc (DVD), floppy disk, and Blu-ray disc where disks usually reproduce data magnetically, while discs reproduce data optically with lasers. Combinations of the above should also be included within the scope of computer-readable media. Additionally, the operations of a method or algorithm may reside as one or any combination or set of codes and instructions on a machine readable medium and computer-readable medium, which may be incorporated into a computer program product.

Various modifications to the implementations described in this disclosure may be readily apparent to those skilled in the art, and the generic principles defined herein may be applied to other implementations without departing from the spirit or scope of this disclosure. Thus, the claims are not intended to be limited to the implementations shown herein, but are to be accorded the widest scope consistent with this disclosure, the principles and the novel features disclosed herein.

Additionally, a person having ordinary skill in the art will readily appreciate, the terms “upper” and “lower” are sometimes used for ease of describing the figures, and indicate relative positions corresponding to the orientation of the figure on a properly oriented page, and may not reflect the proper orientation of any device as implemented.

Certain features that are described in this specification in the context of separate implementations also can be implemented in combination in a single implementation. Conversely, various features that are described in the context of a single implementation also can be implemented in multiple implementations separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. Further, the drawings may schematically depict one more example processes in the form of a flow diagram. However, other operations that are not depicted can be incorporated in the example processes that are schematically illustrated. For example, one or more additional operations can be performed before, after, simultaneously, or between any of the illustrated operations. In certain circumstances, multitasking and parallel processing may be advantageous. Moreover, the separation of various system components in the implementations described above should not be understood as requiring such separation in all implementations, and it should be understood that the described program components and systems can generally be integrated together in a single software product or packaged into multiple software products. Additionally, other implementations are within the scope of the following claims. In some cases, the actions recited in the claims can be performed in a different order and still achieve desirable results.

What is claimed is:

1. A method of wireless communications at a user equipment (UE), comprising:
receiving a configuration of a non-cell defining (NCD) synchronization signal block (SSB) having a periodicity and a time offset;
receiving an indication of a muting pattern that indicates which transmissions of the NCD-SSB are dropped;
receiving at least one transmission of the NCD-SSB based at least in part on the muting pattern.

2. The method of claim 1, further comprising refraining from receiving transmissions of the NCD-SSB that are dropped as indicated by the muting pattern.

3. The method of claim 1, wherein the transmissions of the NCD-SSB that are dropped include all transmissions within a non-active period of a cell discontinuous transmission (DTX) configuration.

4. The method of claim 1, wherein the muting pattern indicates that at least one transmission of the NCD-SSB during a non-active period for a cell DTX configuration is not dropped.

5. The method of claim 4, wherein the at least one transmission of the NCD-SSB during the non-active period for the cell DTX configuration is within a threshold time of a start of an active period of the cell DTX configuration.

6. The method of claim 1, wherein the indication of the muting pattern is a bit string indicating a status of each transmission of the NCD-SSB until the muting pattern repeats.

7. The method of claim 1, further comprising receiving a configuration of an active period and a non-active period for a cell DTX configuration.

8. A method of wireless communications at a network node, comprising:
transmitting a configuration of a non-cell defining (NCD) synchronization signal block (SSB) having a periodicity and a time offset;
determining a configuration of an active period and a non-active period for a cell discontinuous transmission (DTX) configuration; and
dropping at least one transmission of the NCD-SSB when the periodicity and the time offset indicate that the transmission is within the non-active period for the cell DTX configuration.

9. The method of claim 8, wherein the at least one transmission of the NCD-SSB includes all transmissions within the non-active period.

10. The method of claim 8, further comprising transmitting an indication of a muting pattern that indicates which transmissions of the NCD-SSB are dropped.

11. The method of claim 10, wherein the muting pattern indicates that at least one transmission of the NCD-SSB during the non-active period for the cell DTX configuration is not dropped.

12. The method of claim 11, wherein the at least one transmission of the NCD-SSB during the non-active period for the cell DTX configuration is within a threshold time of a start of the active period.

13. The method of claim 10, wherein the muting pattern indicates that all transmissions within the non-active period are dropped.

14. The method of claim 10, wherein the indication of the muting pattern is a bit string indicating a status of each transmission of the NCD-SSB until the muting pattern repeats.

15. The method of claim 8, further comprising transmitting, to one or more user equipment, the configuration of the active period and the non-active period for the cell DTX configuration.

16. An apparatus for wireless communication at a user equipment (UE), comprising:
one or more memories, individually or in combination, storing computer-executable instructions; and
one or more processors, individually or in combination, configured to execute the instructions to:
receive a configuration of a non-cell defining (NCD) synchronization signal block (SSB) having a periodicity and a time offset;
receive an indication of a muting pattern that indicates which transmissions of the NCD-SSB are dropped;
receive at least one transmission of the NCD-SSB based at least in part on the muting pattern.

17. The apparatus of claim 16, wherein the one or more processors, individually or in combination, are configured to refrain from receiving transmissions of the NCD-SSB that are dropped as indicated by the muting pattern.

18. The apparatus of claim 16, wherein the transmissions of the NCD-SSB that are dropped include all transmissions within a non-active period of a cell discontinuous transmission (DTX) configuration.

19. The apparatus of claim 16, wherein the muting pattern indicates that at least one transmission of the NCD-SSB during a non-active period for a cell DTX configuration is not dropped.

20. The apparatus of claim 19, wherein the at least one transmission of the NCD-SSB during the non-active period for the cell DTX configuration is within a threshold time of a start of an active period of the cell DTX configuration.
